(19) United States
(12) Patent Application Publication
(10) Pub. No.: US 2026/0279058 A1
(43) Pub. Date: Sep. 17, 2026

(54) 3D MULTI-SENSOR PERCEPTION AND OBJECT TRACKING

(71) Applicant: NVIDIA Corporation, Santa Clara, CA (US)

(72) Inventors: Yizhou Wang, Milpitas, CA (US); Sameer Satish Pusegaonkar, San Francisco, CA (US); Vishal Kumar, Gurgaon (IN); Chetan Purushottam Sethi, Pune (IN); Yuxing Wang, Burlingame, CA (US); Ganapathy Seshadri Cadungude Aiyer, San Jose, CA (US); Anqi Li, Mountain View, CA (US); Yun He, Santa Clara, CA (US); Kartikay Thakkar, Pune (IN); Zheng Tang, Bothell, WA (US); Swapnil Jagdish Rathi, Pune (IN); Bhushan Narayan Rupde, Pune (IN); Sujit Biswas, Newark, CA (US)

(21) Appl. No.: 19/079,809

(22) Filed: Mar. 14, 2025

(51) Int. Cl. G06V 20/52; G06N 3/0455; G06V 10/764; G06V 10/82

(52) U.S. Cl. CPC G06V 20/52; G06N 3/0455; G06V 10/765; G06V 10/82

(57) ABSTRACT

In various examples, the embodiments disclosed herein describe a 3D perception-based machine learning framework for generating behavior data for detected objects (e.g., objects, persons, animals, machines, etc.) using multi-view optical image data. The framework processes multi-view optical image data from multiple camera sensors, and neural network-based spatial-temporal processing, to generate object behavior data that may be used to facilitate accurate real-time multi-target multi-camera (MTMC) object tracking across a monitored environment. The framework may comprise one or more machine learning models that input multi-view image sensor data and infer behavior data that may include, but is not limited to, 3D bounding shapes, instance features, and/or 3D Re-Identification (ReID) feature embeddings that may be used for assigning an object ID and for extending tracking of detected objects within the monitored environment. To generate an ReID feature embedding, an ReID module may aggregate features from different camera views based on visibility scores.

### CROSS-REFERENCE TO RELATED APPLICATIONS

This application is related to Italian Patent Application No. ______, entitled “3D PERCEPTION AND MULTI-SENSOR OBJECT TRACKING FOR MONITORED ENVIRONMENTS USING MACHINE LEARNING”, matter number 25-RE-0036IT01, which is filed on even date herewith and which is incorporated by reference in its entirety.

### BACKGROUND

Multi-target multi-camera (MTMC) tracking is a computer vision-based technology that simultaneously monitors and tracks the movements of numerous objects (subjects) across multiple camera views—taking input from video feeds captured by multiple (potentially non-overlapping) cameras, and applying algorithms and/or machine learning techniques to analyze video streams to track and identify subjects of interest. MTMC tracking may be used in applications such as security and surveillance, vehicle traffic monitoring, monitoring activities in transit, factories, and warehouses in retail analytics to monitor customer behaviors in a retail store, and/or crowd management/public safety at events, gatherings, or public spaces.

### SUMMARY

Embodiments of the present disclosure relate to three-dimensional (3D) perception for multi-sensor object tracking systems and applications. Systems and methods are disclosed that provide for 3D perception-based object behavior data from multiple optical image sensors that may be used in conjunction with a real-time location system to track objects within a monitored environment.

In contrast to prior location and tracking systems, the embodiments presented herein provide for a 3D perception-based machine learning framework (such as, but not limited to, a Sparse 4D-based framework) that generates behavior data associated with detected subjects (e.g., entities such as objects, persons, animals, machines, etc.) based on optical sensor data. A 3D perception-based Real-Time Location System (3D-RTLS) may leverage 3D perception birds-eye-view (BEV) data from multiple camera sensors deployed across a monitored environment, neural network-based spatial and temporal processing of the 3D perception BEV data, and graphics processing unit (GPU)-based processing, to provide a real-time location system with accurate object tracking across the monitored environment. The 3D-RTLS may accommodate objects in the entire 3D space, which offers improved flexibility and accuracy in comparison to prior location and tracking systems. The 3D perception framework may generate behavior data (e.g., BEV frames) comprising one or more sets of synchronized BEV behavior data, where an individual set may represent BEV behavior data associated with a defined “pod” or “group” of image sensors (which may comprise physical and/or virtual image sensors) within a proximity to each other. That is, a pod of image sensors may capture multi-view optical image data over a cumulative field of view corresponding to the combined fields of view of the individual image sensors that make up that pod. Provided the optical sensor data from a pod of image sensors, a 3D perception framework may generate behavior data (e.g., BEV behavior data) for that pod, which may be referred to as pod behavior data.

A 3D perception framework may comprise one or more machine learning models that input the multi-view image sensor data captured by the image sensors of a pod, and infers behavior data that may include, but is not limited to, 3D bounding shapes (e.g., bounding boxes) corresponding to detected objects (e.g., entities such as objects, persons, animals, machines, etc.), instance features (e.g., an inferred classification identifying a detected object as a person, robot, transporter, forklift, box, pallet, crate, etc.), and/or 3D Re-Identification (ReID) feature embedding that may be used for assigning an object identification (ID) and for extending tracking of detected objects within the monitored environment.

In some embodiments, a 3D perception framework may be implemented using a Sparse 4D-based architecture modified to incorporate ReID features, referred to herein as a Sparse-MTMC architecture. The Sparse-MTMC architecture may comprise a machine learning-based framework designed for 3D object detection and tracking using sparse spatial-temporal fusion. The ReID features generated by the Sparse-MTMC architecture may comprise object embeddings in the form of high-dimensional vectors that uniquely represent each object detected from the combined image data captured by an image sensor pod. The object embedding may be used to match objects tracked across different frames, ensuring that the same object can be consistently identified over time as that object moves between fields of view of different image sensors and across the field of view of different image sensor pods. The ReID features may be integrated with the instance features generated by the Sparse-MTMC architecture. This integration allows the model to leverage both a semantical classification and the unique identity information to improve tracking accuracy. In some embodiments, the Sparse-MTMC architecture may use visualization-based weighting to determine how optical image data from individual sensors of an image sensor pod is integrated in the generation of the ReID feature object embeddings. A visibility module may assign a visibility score to an extracted feature associated with an object on a per-camera basis. To generate the object embedding for an object, the ReID module may aggregate features from different camera views based on visibility scores. In some embodiments, individual incoming frames of multi-view image data may be batch-processed by synchronization logic to align the frames temporally (e.g., based on timestamp metadata applied by the image sensors) such that the frames received at the Sparse-MTMC model are within a predetermined time window.

### BRIEF DESCRIPTION OF THE DRAWINGS

The present systems and methods for 3D perception for multi-sensor object tracking systems and applications are described in detail below with reference to the attached drawing figures, wherein:

FIG. 1 is a data flow diagram for an example 3D perception pipeline for a 3D perception-based Real-Time Location System (3D-RTLS), in accordance with some embodiments of the present disclosure;

FIGS. 2A and 2B are diagrams illustrating an example of the grouping of optical image sensors into image sensor pods, in accordance with some embodiments of the present disclosure;

FIG. 3 is a data flow diagram illustrating an example Sparse-MTMC model, in accordance with some embodiments of the present disclosure;

FIG. 4 is a diagram providing a rendered illustration of pod behavior data, in accordance with some embodiments of the present disclosure;

FIG. 5 is an example data flow diagram for a process for a 3D perception-based Real-Time Location System (3D-RTLS), in accordance with some embodiments of the present disclosure;

FIGS. 6A and 6B are diagrams that illustrate example user interfaces, in accordance with some embodiments of the present disclosure;

FIG. 7 is flow chart diagram for an example method for a 3D perception pipeline, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to 3D perception for multi-sensor object tracking systems and applications. Historically, camera-based tracking technologies have involved either single-object tracking (SOT) or multi-object tracking (MOT) based on image data from a single camera. More recently, multi-camera-based tracking has leveraged developments in multi-camera networks to apply techniques for providing comprehensive monitoring of an area from multiple viewpoints. However, multi-camera tracking introduces complexities with respect to tracking subjects across multiple camera views-including accurate synchronization and calibration between the cameras, addressing appearance changes in a tracked subject that may vary with viewpoint, and fusing data from different video streams to distinctly define subjects and their associated trajectory tracks.

While object Re-Identification (ReID) and other advanced matching algorithms have been developed that can take the outputs of object detection algorithms and match them to compute individual trajectories, those techniques face difficulties with respect to scalability and supporting real-time MTMC tracking from live video streams. Other real-time location systems (RTLSs) have been proposed that perform two-dimensional (2D) perception-based multi-target tracking using real-time (e.g., live) streaming data from multiple sensors based on generating behavior clusters (e.g., a cluster including a set of similar detected behaviors) using hierarchical clustering, where each behavior cluster represents a trackable subject within an area monitored by a set of optical image sensors, and is associated with an anchor and identifier. With this system, inputs are obtained from individual 2D camera tracking results, which may then be projected into three dimensions (3D) to perform 3D tracking. While effective for basic scenarios, 2D perception-based RTLS relies on predefined rules, making it less adaptive to the rich data available for modern learning-based methods. For example, when projecting single-camera results from 2D into 3D, uncertainty is introduced due to the difficulty in accurately determining the full point for a person. This challenge extends to different object classes, such as vehicles or boxes, where locating the center foot-point based solely on 2D detection results is problematic. Consequently, projecting these results into 3D introduces additional uncertainty. Moreover, for complex scenes, extensive fine-tuning is required to maintain accuracy, reducing the system's practicality.

In contrast to prior location and tracking systems, the embodiments presented herein provide for a 3D perception-based machine learning framework (such as, but not limited to, a Sparse 4D-based framework) that generates behavior data associated with detected subjects (e.g., entities such as objects, persons, animals, machines, etc.) based on optical sensor data. A 3D perception-based Real-Time Location System (3D-RTLS) may leverage 3D perception birds-eye-view (BEV) data from multiple camera sensors deployed across a monitored environment, neural network-based spatial and temporal processing of the 3D perception BEV data, and GPU-based processing, to provide a real-time location system with accurate object tracking across the monitored environment. The 3D-RTLS may accommodate objects in the entire 3D space, which offers improved flexibility and accuracy in comparison to prior location and tracking systems.

The 3D perception framework may generate behavior data (e.g., BEV frames) comprising one or more sets of synchronized BEV behavior data, where an individual set may represent BEV behavior data associated with a defined “pod” or “group” of image sensors (which may comprise physical and/or virtual image sensors) within a proximity to each other. That is, an individual image sensor may capture optical sensor data (e.g., BEV sensor data) that captures a field of view covering at least a region of the monitored environment as viewed by that image sensor, whereas a pod of image sensors captures optical sensor data over a cumulative field of view corresponding to the combined fields of view of the individual image sensors that make up that pod. In some embodiments, a pod of image sensors may capture images from a field of view that at least partially overlaps with a field of view of another pod of image sensors. In various embodiments, optical sensor data may include data generated by monocular and/or stereo image sensors.

Provided the optical sensor data from a pod of image sensors, the 3D perception framework described herein may generate BEV behavior data for that pod, which may be referred to as BEV pod behavior data. As described in greater detail herein, the 3D perception framework may comprise one or more machine learning models that input the optical sensor data captured by the image sensors of a pod, and infer BEV pod behavior data that may include, but is not limited to, 3D bounding shapes (e.g., bounding boxes) corresponding to detected objects (e.g., entities such as objects, persons, animals, machines, etc.) within a field of view, and inferred subject classification for a detected object enveloped by a 3D bounding shape (e.g., the detected object may be classified as being a person, robot, transporter, forklift, box, pallet, crate, etc.). The 3D perception framework may further generate Re-Identification (ReID) feature-based tracking data for those detected subjects, BEV image frame timestamps, and/or object identifications (object IDs) in the form of object embeddings associated with the distinct objects detected in the field of view associated with that pod. The object embeddings, which may also be referred to as behavior embeddings, characterize the appearance of one or more features of a tracked object, which essentially avoids the need to rely on single-camera tracking results as was done in prior 2D perception approaches. Moreover, while dense BEV constructions can lead to increased computational demands, especially as the resolution of the BEV map scales up, the 3D perception framework described herein employs a sparse query-based approach, directly operating on multi-view images without having to convert them into a dense BEV format. This reduces computational and memory overhead, enhancing scalability and making the 3D perception framework more suitable for applications that depend on efficient processing (e.g., real-time tracking applications).

As mentioned, in some embodiments a 3D perception framework may be implemented using a Sparse 4D-based architecture modified to incorporate ReID features together with object embedding generation and instance features. This architecture for the 3D perception framework as disclosed herein may be referred to as a Sparse-MTMC architecture. The Sparse-MTMC architecture is a machine learning-based framework designed for 3D object detection and tracking using sparse spatial-temporal fusion. In contrast with approaches that use spatio-temporal transformers for top-down (BEV) multi-object detection, the 3D perception framework described herein can generate embeddings and assign object IDs in addition to performing 3D object detection. In some embodiments, for each object detected by the 3D perception framework, multiple keypoints may be assigned and projected onto multi-view, multiscale, and multi-timestamp image features to sample corresponding features.

In some embodiments, the Sparse-MTMC architecture implements a BEV-based 3D object detection and tracking algorithm designed for structurally static environments. As the term is used herein, a structurally static environment may comprise an enclosed indoor environment (e.g., warehouses, retail stores, and hospitals), a partially enclosed environment (e.g., an open-air arena or amphitheater), or a predominantly outdoor statically bounded environment (e.g., an athletic field, parking lot, campus quad, etc.). In each case, the structurally static environments may be characterized by their ability to be monitored (with respect to tracking objects) by image sensors that are mounted at static locations, and have fields of view that cover at least some portions of the monitored environment. In some embodiments, the Sparse-MTMC architecture may incorporate a camera encoding module to provide the machine learning model of the Sparse-MTMC with context regarding camera placements (e.g., to facilitate spatial aggregation of optical image data). The camera encoding module may receive camera parameters associated with the image sensors that make up an image sensor pod (e.g., intrinsic and extrinsic camera calibration parameters) directly encoding camera placement information by assigning per-camera weights predicted from sampled image features per camera. Intrinsic camera calibration parameters included in a camera encoding may include, for example, field of view angle and focal length, while extrinsic camera calibration parameters included in a camera encoding may include, for example, 3D mounting point coordinates and/or rotation and translation information (e.g., a rotation transformation matrix).

In some embodiments, the Sparse-MTMC architecture comprises a machine learning model that extracts features from the optical sensor data captured by the image sensors of a pod, and infers pod behavior data (e.g., BEV pod behavior data) wherein each detected object may be represented using elements (object features) that may include, but are not limited to: 1) a 3D bounding shape that describes the position, size, and/or orientation of an object; 2) an instance feature comprising high-dimensional semantics (e.g., an object classification correlated to the 3D bounding shape); and 3) ReID features comprising an object embedding mapped to a high-dimensional space, for long-term re-identification of the object to support extended tracking scenarios across image sensor pods.

As mentioned, the ReID module of the Sparse-MTMC architecture facilitates long-term tracking of detected objects across a monitored environment-which permits the 3D perception framework to maintain consistent identification of tracked objects over extended periods, even as they move through different parts of the environment or are temporarily occluded.

The 3D perception framework may generate behavior data (e.g., BEV frames) on a per-pod basis based on optical sensor data over a cumulative field of view corresponding to the combined fields of view of the individual image sensors that make up that pod. The ReID features generated by the Sparse-MTMC architecture may comprise object embeddings in the form of high-dimensional vectors that uniquely represent each object detected from the combined image data captured by an image sensor pod. The object embedding may be used to match objects tracked across different frames, ensuring that the same object can be consistently identified over time as that object moves between fields of view of different image sensors and across the field of view of different image sensor pods. The ReID features may be integrated with instance features generated by the Sparse-MTMC architecture. This integration allows the model to leverage both a semantical classification and the unique identity information to improve tracking accuracy. In some embodiments, to track the same object across multiple frames of behavior data, ReID features may be propagated forward without alteration, allowing the Sparse-MTMC model to focus on refining the ReID features rather than recomputing them from scratch for each frame of behavior data. In some embodiments, training of the machine learning model for the Sparse-MTMC architecture may include introducing controlled noise to instance features during training. For example, a temporal instance denoising module may introduce controlled noise to instance features during training to create “noisy” instances alongside the original ones, such that the model of the Sparse-MTMC architecture may learn to correct these variations, improving robustness to temporal inconsistencies.

In some embodiments, the Sparse-MTMC architecture may use visualization-based weighting to determine how optical image data from individual sensors of an image sensor pod is integrated in the generation of the ReID feature object embeddings. As discussed herein, to uniquely represent each object within the network, the ReID module generates distinct object embeddings for individual objects. Computing object embeddings may involve 3D keypoint generation and feature sampling for each object-which may include fixed keypoints for geometric stability and/or learned keypoints optimized during training. The process of generating object embeddings may include projecting the 3D keypoints of each detected object from a pod of image sensors back into the 2D image plane to extract features from each camera view of the sensors that make up the image sensor pod, and then produce the object embedding for an object based on the extracted features of that object, as extracted from the multiple camera views. To address the issue of some projected 2D points falling outside image boundaries or being occluded, a visibility module may assign a visibility score to each extracted feature associated with an object, on a per-camera basis. For example, to generate the object embedding for an object, the ReID module may include a VisibilityNet module, which aggregates features from different camera views based on visibility scores. For instance, an object might be visible in one camera but not (or partially occluded) in another, resulting in different visibility scores being assigned for each extracted feature vector associated with the different camera views. These visibility scores may be used as weights to aggregate the feature vectors, producing a final feature vector for each object that may be used to produce the ReID feature object embedding of that object. The use of visibility scores as weighting factors in computing the object embedding permits the ReID module to generate robust and accurate embeddings for long-term tracking and identification even when an object has different degrees of visibility, as represented in the optical image data from different optical image sensors.

The Sparse-MTMC architecture of the 3D perception framework may include a pipeline that comprises layers of a machine learning-based neural network divided into an initial spatial aggregation stage followed by a temporal tracking stage—which implements the functions of the ReID module discussed herein. In some embodiments, the Sparse-MTMC architecture is based on an encoder-decoder structure. The inputs to the pipeline may include: 1) multi-view images corresponding to the optical image data from the cameras of an image sensor pod, 2) newly initialized instance features, and 3) propagated object features computed for a previous frame of optical image data from the image sensor pod. The output of the pipeline, as discussed above, may include for one or more objects detected from the multi-view images: 1) a 3D bounding shape that describes the position, size, and/or orientation of an object; 2) an instance feature comprising high-dimensional semantics (e.g., an object classification correlated to the 3D bounding shape); and 3) ReID features comprising an object embedding.

The spatial aggregation stage may input the multi-view optical image data from an optical sensor pod. This data is passed through an image encoder to extract multi-view image features. To ensure model accuracy, additional synchronization logic is applied to the optical image frames before they are sent to the image encoder, maintaining temporal consistency across the multiple camera views of the pod's image sensors. The pipeline processes these multi-view images through a backbone and a feature pyramid network (FPN) to extract multiscale features, providing a rich spatial representation of the scene monitored by that image sensor pod. The Sparse-MTMC model may initialize object anchors corresponding to detected objects. In some embodiments, object detection may be performed at least in part using an iterative clustering algorithm such as K-means clustering (e.g., to group the multi-view optical image data from the multiple cameras of the pod into clusters based on similarity). For each anchor, the model initializes their respective instance feature as zeroes. A first deformable aggregation segment (e.g., of one or more model layers) then performs keypoint generation and feature sampling. 3D keypoints may be generated for each object and may include fixed keypoints for geometric stability and/or learned keypoints optimized during training for scene-specific adaptation. The 3D keypoints may be used for feature sampling across multi-view, multiscale images, reducing computational overhead while maintaining important spatial and temporal information. In some embodiments, the deformable aggregation segment may fuse sampled features through weighted summation, combining instance information from the multiple viewpoints to obtain fused instance features. Deformable aggregation may be performed using a deformable attention layer that gathers image features based on 3D anchor locations. Camera parameters, such as intrinsic and extrinsic calibration parameters for the optical image sensors, may be used to project 3D feature information into 2D and then back to 3D, obtaining real 3D features from 2D data. The first deformable aggregation segment may be followed by a refinement and classification segment (e.g., of one or more model layers) that performs feedforward network functions to output anchors comprising the 3D bounding shape attributes for each detected object, including one or more of location, dimensions, orientation, and/or speed. Each detected object is represented using instance-based object representation, which includes a 3D anchor box describing its position, size, and orientation in world coordinates, and an instance feature containing high-dimensional semantics (e.g., object classification(s)).

The temporal tracking stage may input and process the instance-based object representations produced by the spatial aggregation stage. The temporal tracking stage may include one or more of a cross-attention module, a self-attention module, a second deformable aggregation module, and a refinement and classification module. In some embodiments, the re-identification function performed by the Sparse-MTMC model as discussed herein may be integrated into the deformable aggregation module of this temporal tracking stage. The temporal tracking stage of the Sparse-MTMC model processes the object representations (e.g., object detections and features) computed by the spatial aggregation stage from both the current frame of image data (e.g., time=t) and for at least one previous frame of pod image data (e.g., time=t−1), including their anchors and instance features. The pipeline may feed the object representations from the previous frame into the temporal tracking stage, where anchors and instance features from previous frames may be projected onto the current frame, accounting for the object's movement in the monitored environment. This propagation enables more consistent and robust tracking, even in real-time processing. Instance features may, in some embodiments, be propagated forward without alteration, maintaining a temporal consistency that allows the model to focus on refining rather than recomputing features when processing frames of pod image data. Additionally, during training of a model, a temporal instance denoising segment may introduce controlled noise to instance features, creating “noisy” instances alongside the original ones. Temporal instance denoising thus trains the model to learn to correct these variations, improving robustness to temporal inconsistencies.

The cross-attention layers of the temporal tracking stage may function to combine current anchor object features with the previous anchor object features to discern the detection of new objects appearing in the current frame. For example, cross-attention may fuse multi-view image features with instance queries, accurately representing detected objects in both space and time such that newly appearing objects are readily identified. Moreover, self-attention layers may function to refine the relationships between instance queries, helping the model distinguish objects and improve detection and tracking. The ReID module, integrated into the deformable aggregation layer, obtains image features for different aggregations and anchors, while also extracting the ReID features (e.g., object embeddings) for individual objects. As discussed above, sparse appearance features obtained from the optical image data of individual cameras in the pod may be aggregated into the ReID object embedding using weightings determined from visibility scores. The refinement and classification layers of the temporal tracking stage may (at least in part) implement the decoder portion of the Sparse-MTMC architecture. The decoder may include, for example, a single-frame layer that initializes and scores new instance queries for the current frame, and multi-frame layers that incorporate temporal information from previous frames to improve tracking consistency.

The output of the 3D perception framework may be based on the final object features output from the temporal tracking stage output, and may include the 3D anchor information (e.g., the per-object 3D bounding shape information). In some embodiments, the 3D anchor information may comprise a 3D bounding shape embedding that encodes the 3D bounding shape attributes into a feature vector. The temporal tracking stage output may further include the corresponding instance features and ReID features associated with the individual 3D bounding shapes. In some embodiments, by applying a Sparse-MTMC pipeline as described herein to individual pods, the 3D perception framework may process multi-sensor data and generate a batch of global coordinate-based outputs (e.g., 3D bounding shape information based on a global coordinate system of the monitored environment) for objects detected for an image sensor pod, which can be transmitted into a 3D simulation or collaborative content platform (e.g., NVIDIA Omniverse Kafka) and/or converted into other coordinates for visualization. This 3D perception framework may generate behavior data (e.g., BEV behavior data) per optical image frame that may be used for tracking detected subjects, significantly reducing memory footprint of the 3D perception-based Real-Time Location System while maintaining efficient real-time processing. Moreover, because detection and tracking results are generated in 3D space, the memory footprint to execute the Sparse-MTMC pipeline is optimized since detection and tracking results do not need to be computed for each optical sensor, as the 3D behavior data will be consistent across each sensor.

In some embodiments, the 3D perception framework pipeline may be distributed to deploy inference applications via a software development kit (SDK) such as the NVIDIA DeepStream SDK for performing real-time inference of pod behavior data (e.g., to infer BEV pod behavior data) based on the Sparse-MTMC architecture discussed above. In these embodiments, the NVIDIA DeepStream SDK may be used to decode incoming video streams and leverage its multi-sensor video processing capabilities, enabling concurrent handling of data from multiple cameras—which facilitates comprehensive pod behavior analysis in real-time. DeepStream's data preprocessing, batching, and post-processing features may further optimize throughput and computational resource usage. Model inference may be performed via NVIDIA Triton, seamlessly integrating large-scale execution, and once inference is complete, results are relayed through message brokers for further data processing and downstream analytics in a distributed system. As further described herein, in some embodiments, in addition to the Sparse-MTMC model, a 3D perception framework inference pipeline may comprise an image data preprocessor and a detected object post-processor.

In some embodiments, the image data preprocessor performs optical image frame synchronization for the multi-view frames of optical image data for an optical image pod prior to the input of the optical image data to the Sparse-MTMC model. That is, the individual incoming frames of optical image data from the optical image sensors of the pod may be batch-processed to align the frames temporally (e.g., based on timestamp metadata applied by the image sensors) such that the frames received at the Sparse-MTMC model correspond to a particular time window (e.g., within a predetermined alignment threshold of each other). For example, where the optical image data is captured at 30 frames per second (FPS), an alignment threshold may be set at 33 milliseconds so that the optical image data for a pod as fed to the Sparse-MTMC model is aligned within a timing window of 33 milliseconds. In some embodiments, optical image data from one or more image sensors that cannot be aligned within the alignment threshold will not be passed to the Sparse-MTMC model for inferencing, and the Sparse-MTMC model will operate to infer the pod behavior data based on the reduced set of optical image data from image sensors that can be aligned within the alignment threshold. When alignment of the optical image data from the full complement of image sensors for the pod is again attainable, the Sparse-MTMC model may resume inference of the pod behavior data based on the full set of optical image data. In some embodiments, the preprocessor may perform one or more image processing tasks to the optical image data such as image scaling, resizing, and/or other normalization to standardize the sets of multi-view image frames fed as input to the Sparse-MTMC model. In some embodiments, the preprocessor may perform instance feature initialization to provide initialized instance features (e.g., initialized to zero) as inputs to the Sparse-MTMC. In some embodiments, the preprocessor may perform instance feature initialization based on detected object instance information from the post-processor. That is, the post-processor may receive the pod behavior data produced by the Sparse-MTMC model and perform one or more post-processing operations such as object filtering (e.g., decoder and cache tensors), assigning global IDs to detected objects (e.g., assigned to a bounding shape associated with an object) and managing the global IDs using an instance bank that maintains information on detected object instances. In some embodiments, the post-processor may provide the preprocessor with information on currently detected object instances, which may be used by the preprocessor for initializing instance features for input to the Sparse-MTMC model for processing the next iteration of multi-view frames of optical image data.

In some embodiments, the Sparse-MTMC model of the 3D perception framework may be trained based on synthetic training data generated within a 3D simulation environment (e.g., NVIDIA Omniverse). The 3D simulation platform may render one or more simulations of a structurally static 3D environment from which synthetic optical image data may be captured for one or more virtual image sensor pods. The 3D simulation platform may render structurally static environments such as, but not limited to, an enclosed indoor environment (e.g., warehouses, retail stores, and hospitals), a partially enclosed environment (e.g., an open-air arena or amphitheater), or a predominantly outdoor statically bounded environment (e.g., an athletic field, parking lot, campus quad, etc.). The training dataset may comprise multi-frame image frames representing optical image data captured by multiple simulated static cameras placed in decentralized locations within a scene and organized into defined image sensor pods as described herein. The set of synthetic optical sensor data captured by the virtual image sensors (e.g., virtual cameras) of a pod capture image data for a composite field of view (e.g., a BEV field of view) corresponding to a region of the simulated monitored environment. These virtual image sensors may be strategically positioned to cover most regions in the scene to provide for a comprehensive 3D perception of the simulated monitored environment. The dataset includes multiple image sensor pod groupings to ensure scalability and the ability to handle larger scenes effectively. Such groupings allow the Sparse-MTMC model under training to be trained using multi-view image frames from multiple sensors efficiently, enhancing the Sparse-MTMC model's performance. In addition to the static structural elements of the simulated environment (e.g., walls, support structures, warehouse shelving, etc.), the 3D simulation platform further simulates the movement of one or more objects through the simulated environment, which may appear from multiple viewpoints in the synthetic optical sensor data and be detected as objects by the Sparse-MTMC model as discussed above. The dataset may be designed to support multi-class object detection, focusing on common objects found in indoor environments (e.g., warehouses). For example, 3D simulation platform may render objects in the simulated environments corresponding to object classes such as, but not limited to, a person, a robot, a transporter, a forklift, a box, a pallet, and/or a crate. That being said, in some embodiments, a dataset may be designed to be generalizable across different scenarios, such as warehouses, retail stores, and hospitals, providing the Sparse-MTMC model with a substantial degree of versatility with respect to the environments in which it may be deployed. Moreover, because the 3D object instances generated into the simulated environment are of a known appearance, size, and/or placement, the 3D simulation platform may produce the corresponding ground truth data regarding 3D bounding shape information, instance features, and ReID features associated with pod behavior data produced by the Sparse-MTMC model. In some embodiments, ground truth depth maps are included in the training dataset to improve model convergence and detection accuracy by providing 3D information during training related to objects and/or surfaces included in the synthetic optical image data.

In some embodiments, a training step of the training process may include the initialization of anchors using K-Means clustering from ground truth 3D bounding shapes in the training set. In the training process, the Sparse-MTMC model pipeline takes inputs such as, but not limited to, the synthetic multi-view optical image data, image sensor calibration parameters (e.g., intrinsic and/or extrinsic camera calibration parameters for the virtual image sensors of the pod), and the ground truth depth maps, and produces an inference output comprising object behavior data. For clarity, it should be noted that depth maps need not be provided as an input to the model for production inference processes outside of training. As discussed, training steps may involve training on synthetic optical image data representing images captured by the virtual sensors of an image sensor pod. As such, the training process may involve splitting the scene into several image sensor pods, each pod including multiple image sensors having a field of view over the monitored environment. That is, a pod of virtual image sensors captures optical sensor data over a cumulative field of view corresponding to the combined fields of view of the individual virtual image sensors that make up that pod. In some embodiments, a pod of virtual image sensors may capture images from a field of view that at least partially overlaps with a field of view of another pod of image sensors. For example, in a scene generated by the 3D simulation platform with 100 cameras, the cameras may be divided into ten image sensor pods, with individual sensor pods having a defined number of sensors (e.g., 10 sensors). This logical division of optical sensors into pods facilitates efficient training and accurate model training by providing good camera coverage across the entire scene.

In some embodiments, training the Sparse-MTMC model may involve computing one or more loss functions based on deviations between ground truth 3D bounding shapes and ground truth depth maps and the predicted object behavior data. Neural weighting factors of the Sparse-MTMC model may be iteratively adjusted over a series of training steps to drive such loss functions to a minimum (e.g., within a threshold). In some embodiments, training the Sparse-MTMC model employs a triplet loss function for training the ReID module. During training, the pipeline uses the triplet loss to refine the ReID features, ensuring that each object has a unique representation. The triplet loss function ensures that the embeddings associated with a detected object are similar over time, while the embeddings of different objects are substantially dissimilar, enhancing the model's ability to accurately identify and track objects temporally over sequences of image frames. In some embodiments, training of the ReID module may include creating “noisy” instances alongside the original instances, enabling the Sparse-MTMC model to learn to correct variations and improve robustness to temporal inconsistencies.

In some embodiments, multi-GPU support is provided by running individual Sparse-MTMC models for individual image sensor pods on separate GPUs, which facilitates real-time inferencing on a large number of sensors by dividing those sensors into multiple image sensor pods. Multiple image sensor pods can be deployed across various processing architectures (e.g., Blackwell, Hopper, Ada Lovelace, Turing, and Ampere) with 3D perception frameworks at least partially hosted as a service (e.g., a microservice) on servers of a cloud computing platform. For example, an engine file (e.g., a TensorRT model object) for implementing a 3D perception framework may be generated dynamically based on the particular architecture hosting the service. In some embodiments, dynamic batch-size support (e.g., with respect to multi-view optical image data) may be used to optimize (e.g., maximizes) GPU utilization, and efficient data copying within the pipeline may be achieved using, e.g., NVIDIA Triton, leading to low-latency processing even for large-scale data.

In some embodiments, a 3D perception-based Real-Time Location System (3D-RTLS) may input pod behavior data generated for one or more image sensor pods by one or more 3D perception frameworks as described herein. By using a 3D perception-based machine learning-based framework, a 3D perception framework model may be trained on detecting the 3D bounding shapes, resulting in more reliable localization and tracking results in 3D space, and providing BEV pod behavior data that may be more readily leveraged by the subsequent 3D-RTLS tracking architecture. The output produced by the 3D-RTLS may comprise 3D object tracking data generated in real-time that includes timestamped frames of 3D bounding shapes and object IDs for respective tracked subjects within the monitored environment.

In some embodiments, the 3D-RTLS may use the 3D object tracking data to render a user interface (UI) on a human-machine interface display. The UI may present a comprehensive computer vision-based view of the monitored environment. For example, the RTLS may use the location and/or trajectory data to display corresponding bounding shapes to indicate a predicted location and/or tracking information associated with each tracked subject. In some embodiments, the 3D-RTLS may generate a computer vision-based BEV display and/or a top-down view of the monitored area-displaying the location and/or tracking of each tracked subject. In some embodiments, the 3D-RTLS may generate a display of a computer vision-based environment corresponding to a viewpoint of one or more of the real image sensors providing the real-time live streaming data, and/or of a viewpoint of one or more virtual camera views instantiated within the computer vision-based environment. In some embodiments, a combined BEV visualization of multiple cameras can be overlaid onto a floor map of the entire scene or a portion thereof.

In some embodiments, a tracked subject may be selected via the user interface and their movements tracked through the computer vision-based environment based on the 3D object tracking data. An object ID (or another corresponding identifier) may be displayed for one or more of the subjects tracked through the monitored environment. In some embodiments, the RTLS may generate an output representing data from the behaviors of one or more of the objects being tracked in the monitored environment. The output may be used as input for other systems. For example, in some embodiments, a navigation control system for a mobile machine, such as an autonomous mobile robot (AMR) and/or an ego machine, may dynamically route the mobile machine away from using a path that may be congested by the presence of tracked subjects (e.g., people) on the path. In other embodiments, the output from the 3D-RTLS may be used by a security system to track a person of interest in real-time as they traverse through the monitored environment.

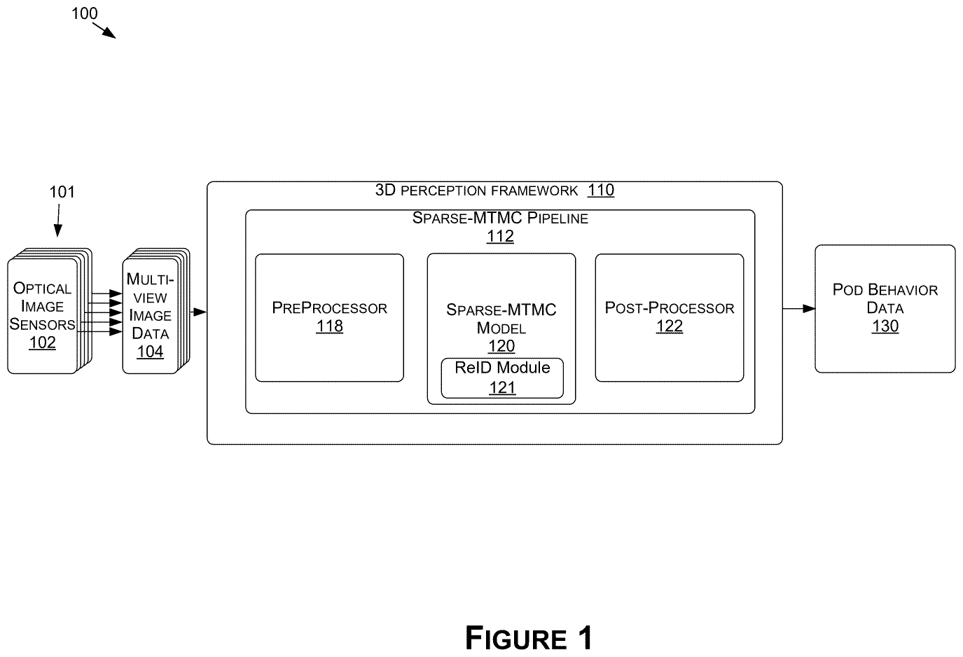

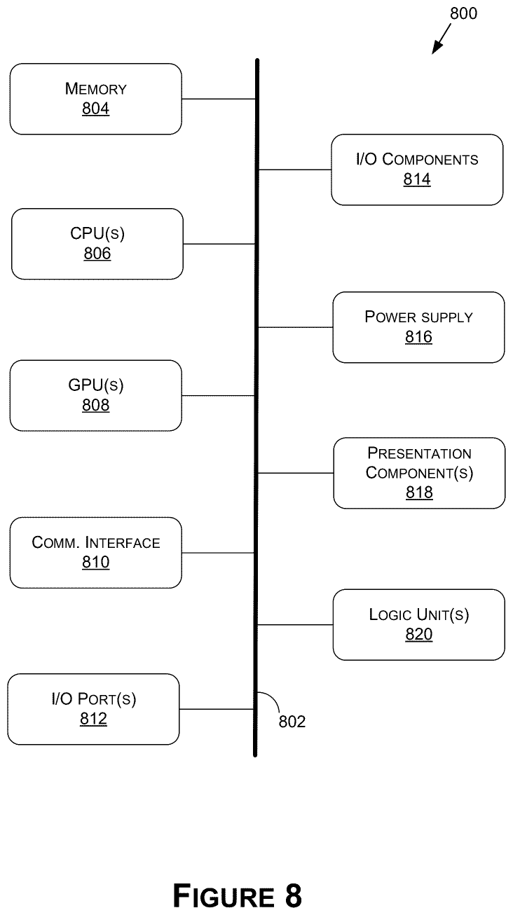

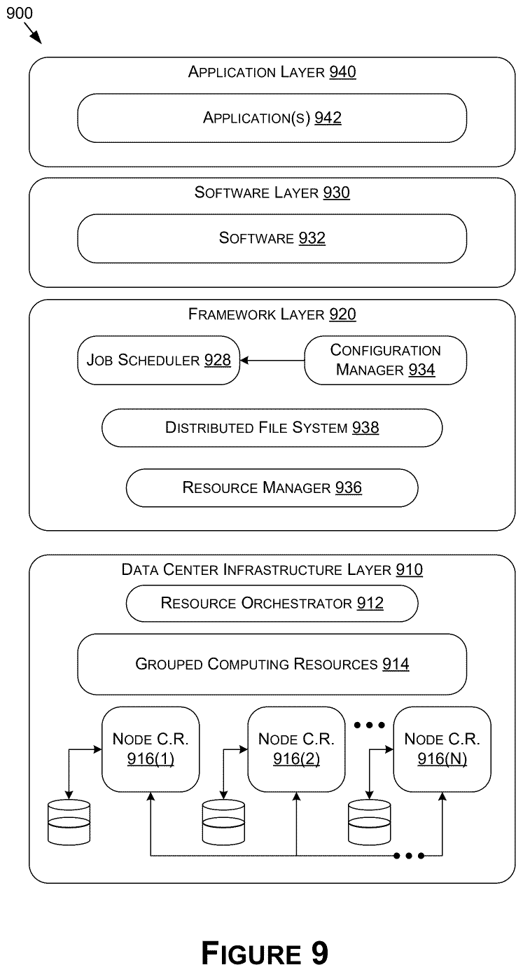

FIG. 1 is an example data flow diagram for a 3D perception pipeline 100 for a 3D perception-based Real-Time Location System (3D-RTLS), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., processing units, processing circuitry, etc.) executing instructions stored in memory. In some embodiments, the systems, methods, and processes described herein may be executed using similar components, features, and/or functionalities to those of example computing device 800 of FIG. 8, and/or example data center 900 of FIG. 9.

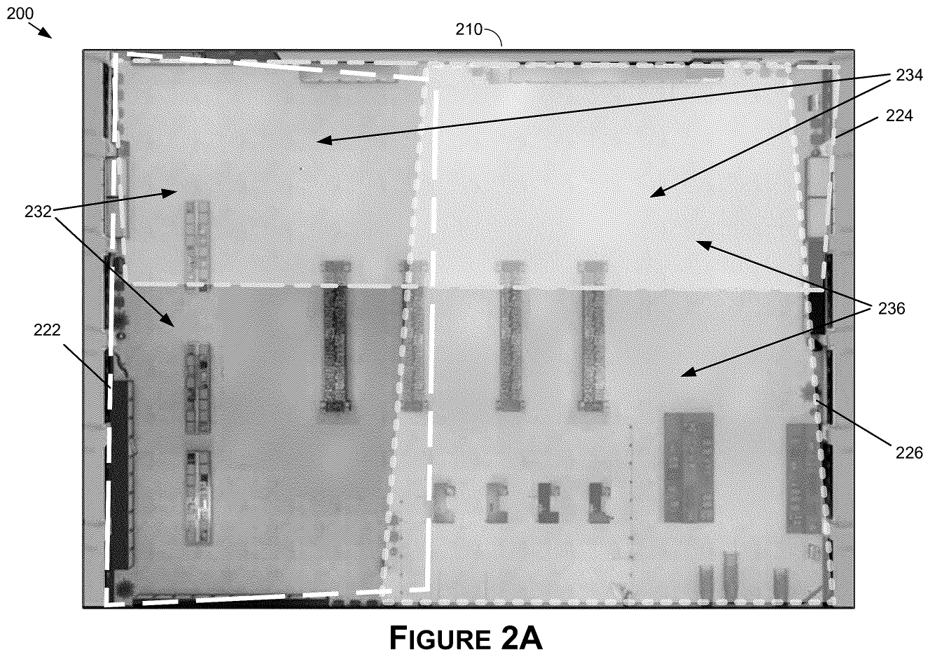

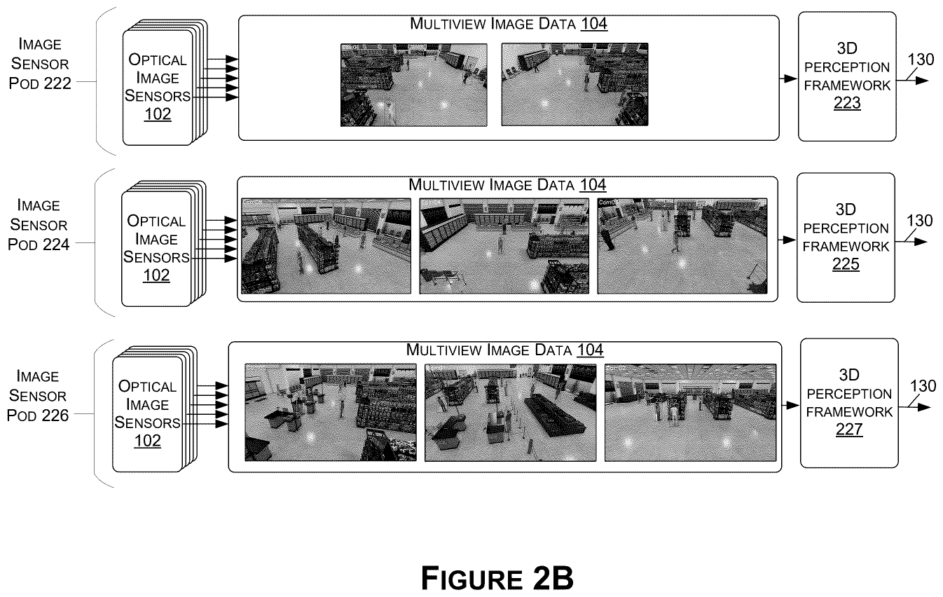

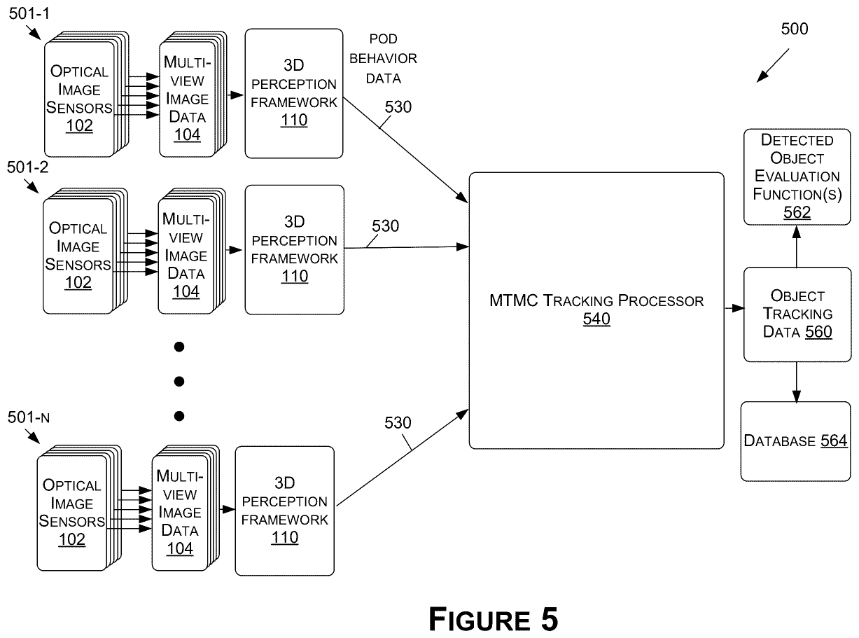

In some embodiments, a 3D perception pipeline 100 may receive multi-view image data 104 from a plurality of optical image sensors 102 (e.g., cameras) deployed across a monitored environment to track the location and/or trajectory of a plurality of entities (e.g., objects, people, robots, etc.) across the monitored environment, such as discussed in greater detail with respect to FIGS. 2A, 2B, and FIG. 5. As shown in FIG. 1, multi-view image data 104 from an optical image sensor pod 101 may be fed as input to a 3D perception framework 110 that processes the multi-view image data 104 associated with that particular optical image sensor pod 101. The 3D perception framework 110 may process the multi-view image data 104 for an optical image sensor pod 101 to infer pod behavior data 130 for that pod 101, which may be referred to as pod behavior data 130.

For example, FIG. 2A is a diagram at 200 of a monitored environment 210 that illustrates an example of grouping of optical image sensors 102 into image sensor pods. More specifically, in this example a first image sensor pod 222 may produce multi-view image data 104 from a first region 232 of the monitored environment 210, a second image pod 224 may produce multi-view image data 104 from a second region 234 of the monitored environment 210, and a third image pod may produce multi-view image data 104 from a third region 236 of the monitored environment 210. As shown in FIG. 2A, the region monitored by an image sensor pod may, in some implementations, at least partially overlap with the region monitored by another image sensor pod. Here, the monitored environment 210 is depicted in the form of a grocery store, but it should be appreciated that in various embodiments, the monitored environment 210 may comprise any area where object tracking is desired such as, but not limited to, warehouses, factories, retail establishments, hospitals, office buildings, secured facilities, arenas, public transportation stations, parks, public spaces, and the like. The image data pipelines associated with the image sensor pods 222, 224, and 226 are further illustrated by example in FIG. 2B. As shown in FIG. 2B, the image sensor pod 222 may comprise optical image sensors 102 that generate multi-view image data 104 that includes optical images from (e.g., two) fields of view that cover the first region 232. This multi-view image data 104 for image sensor pod 222 is fed to a 3D perception framework 223 (e.g., a 3D perception framework 110, as illustrated in FIG. 1) to produce pod behavior data 130 for the first region 232 covered by image sensor pod 222. The image sensor pod 224 may comprise optical image sensors 102 that generate multi-view image data 104 that includes optical images from (e.g., three) fields of view that cover the second region 234. This multi-view image data 104 for image sensor pod 224 is fed to a 3D perception framework 225 (e.g., a 3D perception framework 110 as illustrated in FIG. 1) to produce pod behavior data 130 for the second region 234 covered by image sensor pod 224. The image sensor pod 226 may comprise optical image sensors 102 that generate multi-view image data 104 that includes optical images from (e.g., three) fields of view that cover the third region 236. This multi-view image data 104 for image sensor pod 226 is fed to a 3D perception framework 227 (e.g., a 3D perception framework 110 as illustrated in FIG. 1) to produce pod behavior data 130 for the third region 236 covered by image sensor pod 226.

The plurality of optical image sensors 102 may be assigned to an image sensor pod 101, for example, based on the proximity and/or overlap and/or their individual fields of view. That is, an individual optical image sensor 102 may capture multi-view image data 104 (e.g., BEV sensor data) that represent a field of view covering at least a region of the monitored environment as viewed by that optical image sensor 102, whereas a pod 101 of optical image sensors 102 captures multi-view image data 104 representing a cumulative field of view corresponding to the combined fields of view of the individual image sensors 102 that make up that image sensor pod 101. In various embodiments, multi-view image data 104 may include data generated by image sensors 102 that comprise monocular and/or stereo image sensors.

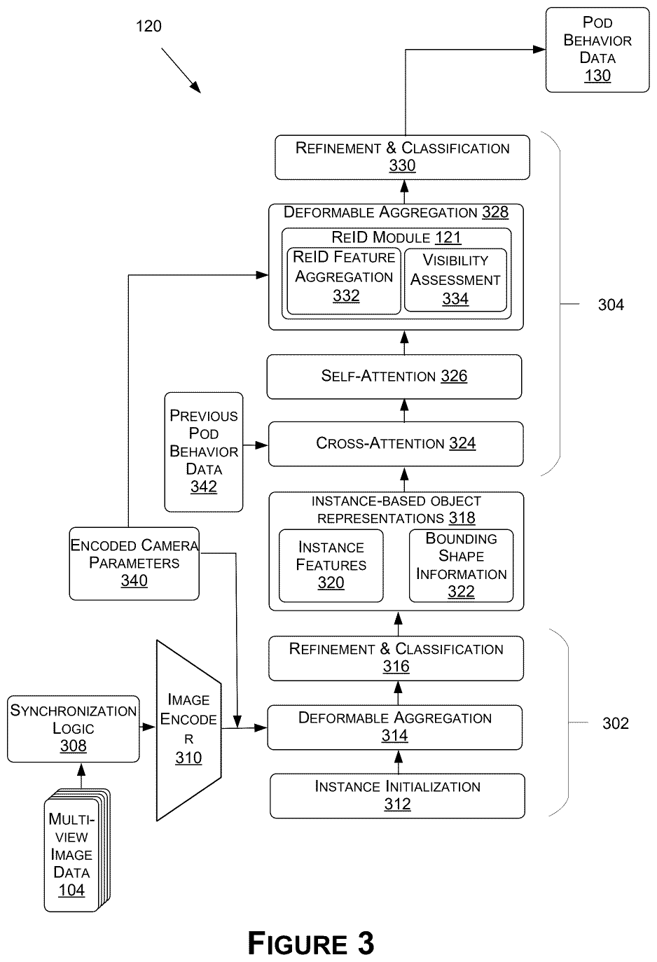

As shown in FIG. 1, a 3D perception framework 110 may comprise a Sparse-MTMC pipeline 112 for generating pod behavior data 130 from multi-view image data 104. The Sparse-MTMC pipeline 112 may include, for example, a preprocessor 118, a Sparse-MTMC model 120, and a post-processor 122. The Sparse-MTMC model 120 may include an integrated ReID module 121 for generating ReID feature embeddings, as discussed herein. The ReID module 121 facilitates long-term tracking of detected objects across a monitored environment-which permits the 3D perception framework to maintain consistent identification of tracked objects over extended periods, even as they move through different parts of the environment or are temporarily occluded. In some embodiments, the image data preprocessor 118 comprises synchronization logic (e.g., synchronization logic 308 as shown in FIG. 3) that performs optical image frame synchronization for the multi-view frames of the multi-view image data 104 for image sensor pod 101 prior to the input of the optical image data to the Sparse-MTMC model 120. The individual incoming frames of multi-view image data 104 may be batch-processed by the synchronization logic 308 to align the frames temporally (e.g., based on timestamp metadata applied by the image sensors) such that the frames received at the Sparse-MTMC model 120 are within a predetermined time window (e.g., within an alignment threshold of each other). For example, where the multi-view image data 104 is captured at 30 frames per second (FPS), an alignment threshold may be set at 33 milliseconds so that the multi-view image data 104 for a pod as fed to the Sparse-MTMC model 120 by the preprocessor 118 is aligned within a timing window of 33 milliseconds. In some embodiments, optical image data from one or more of the optical image sensors 102 that cannot be aligned within the alignment threshold will not be passed to the Sparse-MTMC model 120 for inferencing, and the Sparse-MTMC model 120 will operate to infer the pod behavior data 130 based on the reduced set of multi-view image data 104 obtained from those optical image sensors 102 that can be aligned within the alignment threshold. When alignment of the optical image data from the full complement of image sensors for the pod is again attainable, the Sparse-MTMC model 120 may resume inference of the pod behavior data based on the full set of multi-view image data 104. In some embodiments, the preprocessor 118 may perform one or more image processing tasks to the multi-view image data 104 such as image scaling, resizing, and/or other normalization to standardize the sets of synchronized multi-view image data 104 frames fed as input to the Sparse-MTMC model 120. In some embodiments, the preprocessor 118 may perform instance feature initialization (e.g., instance initialization 312 shown in FIG. 3) to provide initialized instance features (e.g., initialed to zero) as inputs to the Sparse-MTMC model 120. In some embodiments, the preprocessor 118 may perform instance feature initialization based on detected object instance information from the post-processor 122. That is, the post-processor 122 may receive the pod behavior data produced by the Sparse-MTMC model 120 and perform one or more post-processing operations such as object filtering (e.g., decoder and cache tensors), assigning global IDs to detected objects (e.g., assigned to a bounding shape associated with an object) and managing the global IDs using an instance bank that maintains information on detected object instances. In some embodiments, the post-processor 122 may provide the preprocessor 118 with information on currently detected object instances, which may be used by the preprocessor 118 for initializing instance features for input to the Sparse-MTMC model 120 for processing the next iteration of multi-view frames of optical image data.

In some embodiments, the pod behavior data 130 produced by the 3D perception framework 110 may comprise BEV pod behavior data. A 3D perception framework 110 may initialize multiple 3D perception pipelines, wherein a 3D perception pipeline collects multi-view image data 104 from the image sensors 102 of a pod 101 and applies a model (e.g., a Sparse-MTMC model 120 architecture) to generate the set of the pod behavior data 130 for that pod 101. As a non limiting example, in some embodiments, a Sparse-MTMC pipeline 112 may process multi-view image data 104 comprising individual feeds for a large number (e.g., 15 to 20 or more) of optical image sensors 102 that are grouped into a pod 101. Pod behavior data 130 comprises 3D information characterizing detected objects such as 3D bounding shapes (e.g., bounding boxes) corresponding to detected objects (e.g., entities such as objects, persons, animals, machines, etc.) within the combined field of view of the pod 101, an instance feature comprising high-dimensional semantics (e.g., an object classification correlated to a 3D bounding shape classifying an object as being, for example, a persons, a box, a forklift, etc.) and may include other metadata such as short-term tracking data for detected objects and/or image frame timestamps.

In some embodiments, the 3D perception framework 110 may further output object embeddings (e.g., behavior embedding) that characterize the appearance of one or more features of a tracked subject, which support extended tracking scenarios across image sensor pods. An object embedding for a detected object may comprise an aggregation of object embeddings extracted from the multiple views of the object available from the optical image sensors 102 or a pod 101, and may serve as a unique characterization of a detected object that may be used for deriving a unique object ID for that object. For example, in some embodiments, a vector representing the object embedding itself may serve as an object ID for a detected object. In some embodiments, a vector representing the object embedding itself may be cross-referenced (e.g., via a lookup table) to a less complex and/or meaningful identifier (e.g., a customer ID, equipment ID, package ID, employee ID, etc.) that serves as the object ID. The pod behavior data 130 for a given pod may be considered as representing behavior data for a virtualized composite sensor covering a particular monitoring region of the monitored environment. By using a 3D perception-based machine learning-based framework, the 3D perception framework 110 model may be trained on detecting the 3D bounding shapes, resulting in more reliable localization and tracking results in 3D space, and providing pod behavior data 130 that may be more readily leveraged by the subsequent tracking systems, such as the MTMC tracking processor 540 discussed herein. In some embodiments, the 3D perception framework 110 and/or Sparse-MTMC pipeline 112 may be distributed to deploy inference applications via a software development kit (SDK) such as the NVIDIA DeepStream SDK for performing real-time inference of pod behavior data (e.g., to infer BEV pod behavior data) based on the Sparse-MTMC architecture discussed above. In such embodiments, the NVIDIA DeepStream SDK may be used to decode incoming video streams of multi-view image data 104 and leverage its multi-sensor video processing capabilities, enabling concurrent handling of data from multiple optical image sensors 102—which facilitates comprehensive pod behavior analysis in real-time. DeepStream's data preprocessing, batching, and post-processing features may further optimize throughput and computational resource usage. In some embodiments, Sparse-MTMC model 120 inference processes may be performed via NVIDIA Triton, seamlessly integrating large-scale execution. When inference is complete, pod behavior data 130 results may be relayed through message brokers for further data processing and downstream analytics in a distributed system (e.g., detected object evaluation function(s) 562 as shown in FIG. 5).

As illustrated in FIG. 3, a Sparse-MTMC model 120 of the 3D perception framework 110 may include a pipeline that comprises layers of a machine learning-based neural network divided into an initial spatial aggregation stage 302 followed by a temporal tracking stage 304. In some embodiments, the functions of the ReID module discussed herein may be implemented by the temporal tracking stage 304. In some embodiments, the Sparse-MTMC model 120 architecture may be based on an encoder-decoder structure. As shown in FIG. 3, inputs to the Sparse-MTMC model 120 pipeline may include: multi-view image data 104 corresponding to the optical image data from the cameras of an image sensor pod, newly initialized instance features 312, and/or previous pod behavior data 342, which may include propagated object features computed for a previous frame of optical image data from the image sensor pod. The output of the pipeline, as discussed above, may include pod behavior data 130, which includes for one or more objects detected from the multi-view image data 104: a 3D bounding shape that describes the position, size, and/or orientation of a detected object, an instance feature comprising high-dimensional semantics (e.g., an object classification correlated to the 3D bounding shape), and 3D ReID features comprising an object embedding.

In some embodiments, the spatial aggregation stage 302 may input the multi-view optical image data 104 from an optical sensor pod (e.g., as illustrated in FIGS. 2A and 2B). This multi-view image data 104 is passed through an image encoder 310 to extract multi-view image features for processing by the spatial aggregation stage 302. To ensure model accuracy, synchronization logic 308 may be applied to optical image frames of the multi-view image data 104 before they are processed by the image encoder 310, maintaining temporal consistency across the multiple camera views of the pod's image sensors 102. In some embodiments, the deformable aggregation 314 processes the synchronized multi-view image data 104 through a backbone and a feature pyramid network (FPN) to extract multiscale features, providing a rich spatial representation of the scene monitored by that image sensor pod. The Sparse-MTMC model 120 may perform instance initialization 312 to initialize object anchors corresponding to detected objects. In some embodiments, object detection may be performed by the deformable aggregation 314 layers at least in part using an iterative clustering algorithm such as K-means clustering (e.g., to group the multi-view optical image data from the multiple image sensors 102 of the pod into clusters based on similarity). For each anchor, the spatial aggregation stage 302 may initialize their respective instance feature as zeroes. The first deformable aggregation 314 may perform keypoint generation and feature sampling. Three-dimensional keypoints may be generated for one or more (e.g., up to all) detected objects and may include fixed keypoints for geometric stability and/or learned keypoints optimized during training for scene-specific adaptation. The 3D keypoints may be used for feature sampling across multi-view, multiscale images, reducing computational overhead while maintaining important spatial and temporal information.

In some embodiments, the deformable aggregation 314 may fuse sampled features through weighted summation, combining instance information from the multiple viewpoints to obtain fused instance features. Deformable aggregation 314 may be performed using one or more deformable attention neural network layers that gather image features based on 3D anchor locations. In some embodiments, encoded camera parameters 340 (e.g., intrinsic and/or extrinsic calibration parameters for one or more of the optical image sensors 102) may be input to the deformable aggregation 314 and used to project 3D feature information into 2D and then back to 3D, obtaining real 3D features from 2D data. As shown in FIG. 3, the first deformable aggregation 314 may be followed by a refinement and classification segment 316 (e.g., comprising one or more neural network layers) that performs feedforward network functions to output anchors comprising the 3D bounding shape information for each detected object (e.g., one or more of location, dimensions, orientation, and/or speed with respect to global coordinates). As shown in FIG. 3, the output generated by spatial aggregation stage 302 may comprise instance-based object representations 318 which may include the 3D bounding shape information 322 and instance features 320 containing high-dimensional semantics (e.g., object classification(s)).

The temporal tracking stage 304 may input and process the instance-based object representations 318 produced by the spatial aggregation stage 302. The temporal tracking stage 304 may include one or more of a cross-attention module 324, a self-attention module 326, a second deformable aggregation module 328, and a refinement and classification module 330. In some embodiments, the ReID module 121 of the Sparse-MTMC model 120 as discussed herein may be integrated into the deformable aggregation module 328 of this temporal tracking stage 304.

The temporal tracking stage 304 of the Sparse-MTMC model 120 processes the object representations 318 (e.g., object detections and features) computed by the spatial aggregation stage 302 based on the current frame multi-view image data 104 (e.g., for time=t) and the behavior data derived for at least one frame of previous pod behavior data 342 (e.g., for time=t−1), including their anchors and instance features. For example, object representations 318 from a previous frame may be fed into the cross-attention 324 layers of the temporal tracking stage 304, where anchors and instance features from previous frames may be projected onto the current frame of object representations 318, accounting for the object's movement in the monitored environment. This propagation enables more consistent and robust tracking, even in real-time processing. Instance features may, in some embodiments, be propagated forward without alteration, maintaining a temporal consistency that allows the model to focus on refining rather than recomputing features when processing frames of pod image data. Additionally, during training of a Sparse-MTMC model 120, a temporal instance denoising segment may introduce controlled noise to instance features, creating “noisy” instances alongside the original ones. Temporal instance denoising thus trains the model to learn to correct these variations, improving robustness to temporal inconsistencies. In some embodiments, the cross-attention 324 layers of the temporal tracking stage 304 may function to combine current object representations 318 with the previous anchor object representations 318 (from previous pod behavior data 342) to discern the detection of new objects appearing in the current frame. For example, cross-attention 324 may fuse multi-view image features with instance queries, accurately representing detected objects in both space and time such that newly appearing objects are readily identified. Moreover, self-attention 326 layers may function to refine the relationships between instance queries, helping the model distinguish objects and improve detection and tracking.

In some embodiments, the ReID module 121 integrated into the deformable aggregation layer 328 obtains image features for different aggregations and anchors, while also extracting the ReID features (e.g., object embeddings) for individual detected objects. To uniquely represent each object within the network, the ReID module 121 may generate distinct 3D object embeddings for individual objects based on aggregating 2D object embeddings. For example, in some embodiments, the ReID module 121 comprises ReID feature aggregation 332. The ReID feature aggregation 332 may compute object embeddings based on 3D keypoint generation and feature sampling for each detected object. In some embodiments, 3D keypoint generation may include generating fixed keypoints for geometric stability and/or learned keypoints optimized during training. In some embodiments, the ReID feature aggregation 332 may perform a projection of 3D keypoints of each detected object from a pod of image sensors onto a 2D image plane to extract features from the individual image sensor views of the sensors that make up the image sensor pod. The ReID feature aggregation 332 may then produce the 3D ReID feature embedding for a detected object based on the aggregation of extracted features of that object as extracted from the multiple camera views. In some embodiments, the ReID module 121 may perform a visibility assessment 334 (e.g., a VisibilityNet module) to address the issue of some projected 2D points falling outside image boundaries or being occluded. The visibility assessment 334 may comprise a module that computes and assigns a visibility score on a per-camera basis to each view of an extracted feature of the detected object. In some embodiments, to generate a 3D ReID feature embedding for an object, the ReID feature aggregation 332 may aggregate features from the different image sensor views based on the visibility scores computed by the visibility assessment 334. For instance, an object might be visible in one camera but not (or partially occluded) in another, resulting in different visibility scores being assigned for each extracted feature vector associated with the different camera views. These visibility scores may be used as weights by the ReID feature aggregation 332 to aggregate single view-based feature vectors to produce the final feature vector for each object for the ReID feature embedding for that object. The use of visibility scores as weighting factors in computing the object embedding permits the ReID module 121 to generate robust and accurate embeddings for long-term tracking and identification even when an object has different degrees of visibility, as represented in the optical image data from different optical image sensors 102.

As discussed above, sparse appearance features obtained from the optical image data of individual cameras in the pod may be aggregated into the ReID object embedding using weightings determined from visibility scores. The refinement and classification layers of the temporal tracking stage 304 may at least in part implement the decoder portion of the Sparse-MTMC architecture. The decoder may include, for example, a single-frame layer that initializes and scores new instance queries for the current frame, and multi-frame layers that incorporate temporal information from previous frames to improve tracking consistency.

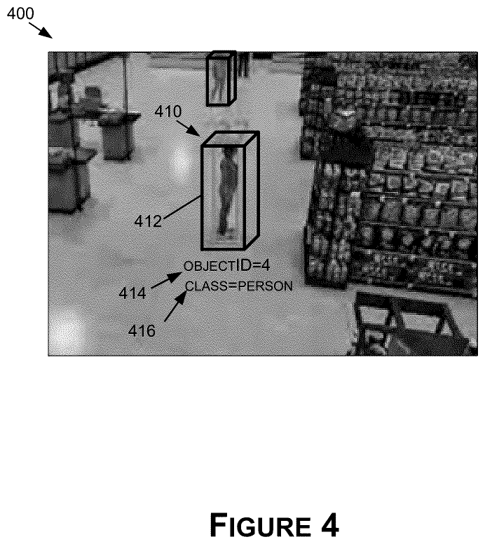

The pod behavior data 130 output from a 3D perception framework 110 may be based on the final object features output from the temporal tracking stage 304, and may include the 3D anchor information (e.g., the per-object 3D bounding shape information). In some embodiments, the 3D anchor information may comprise a 3D bounding shape embedding that encodes the 3D bounding shape attributes into a feature vector. The temporal tracking stage 304 output may further include the corresponding instance features and ReID features associated with the individual 3D bounding shapes. For illustrative purposes, FIG. 4 is a diagram providing a rendered illustration 400 of pod behavior data 130 that may be generated with respect to an individual detected object 410. As shown in FIG. 4, for an individual detected object 410, behavior data may include a 3D bounding shape 412 (a 3D bounding box, in this example) that may indicate characteristics such as dimensions, shape, size, and/or orientation (rotation angle) of the detected object 410. In some embodiments, the behavior data may include a global ID 414 (e.g., an object ID that may be derived from an ReID feature embedding) and/or an instance feature 416 (e.g., an object classification—a person, a box, a forklift, etc.). Having 3D bounding shapes produced by the 3D perception framework 110 around a tracked subject may generate a richer dataset of pod behavior data 130 for further processing than merely having 3D location data for a tracked subject, because a 3D bounding shape can further indicate characteristics such as dimensions, shape, size, and/or angle of the detected object. Moreover, ReID feature embeddings incorporated in the pod behavior data 130 may be used to derive object IDs to track objects, and augment the context available for recognizing associations between 3D bounding shapes, while realizing a less complex 3D perception-based detection pipeline as compared to prior approaches.

In some embodiments, by applying a Sparse-MTMC pipeline 112 as described herein to multi-view image data 104 of individual pods, the 3D perception framework 110 may process multi-sensor data and generate a batch of global coordinate-based outputs of pod behavior data 130, which can be transmitted into a 3D simulation or collaborative content platform (e.g., NVIDIA Omniverse Kafka) and/or converted into other coordinates for visualization. The 3D perception framework 110 may generate behavior data pod (e.g., BEV behavior data) per optical image frame that may be used for tracking detected objects, significantly reducing memory footprint of a 3D perception-based Real-Time Location System while maintaining efficient real-time processing. For example, because detection and tracking results are generated in 3D space, the memory footprint to execute the Sparse-MTMC pipeline 112 is optimized since detection and tracking results do not need to be computed for each optical image sensor 102, as the 3D behavior data processed by the Sparse-MTMC model 120 will be consistent across each of the optical image sensors 102 of the pod 101.

In some embodiments, the Sparse-MTMC model 120 of the 3D perception framework 110 may be trained based on synthetic training data, such as data generated within a 3D simulation environment (e.g., NVIDIA Omniverse). The 3D simulation platform may render one or more simulations of a structurally static 3D environment from which synthetic optical image data may be captured for one or more virtual image sensor pods 101. A 3D simulation platform may render structurally static environments for generating a Sparse-MTMC model 120 training dataset such as, but not limited to, an enclosed indoor environment (e.g., warehouses, retail stores, and hospitals), a partially enclosed environment (e.g., an open-air arena or amphitheater), or a predominantly outdoor statically bounded environment (e.g., an athletic field, parking lot, campus quad, etc.). The training dataset may comprise multi-frame image frames representing optical image data captured by multiple simulated static cameras placed in decentralized locations within a scene and organized into defined image sensor pods as described herein. The set of synthetic optical sensor data captured by the virtual image sensors 102 (e.g., virtual cameras) of a pod 101 capture image data for a composite field of view (e.g., a BEV field of view) corresponding to a region of the simulated monitored environment. These virtual image sensors may be strategically positioned to cover most regions in the scene, to provide for a comprehensive 3D perception of the simulated monitored environment.

The training dataset may include multiple image sensor pod groupings (e.g., as illustrated in FIGS. 2A and 2B) to ensure scalability and the ability to handle larger monitored environments effectively. Such groupings allow the Sparse-MTMC model 120 under training to be trained using multi-view image frames from multiple sensors efficiently, enhancing the Sparse-MTMC model 120's performance. In addition to static structural elements of the simulated environment (e.g., walls, support structures, warehouse shelving, etc.), the 3D simulation platform may further simulate the movement of one or more objects through the simulated environment, which may appear from multiple viewpoints in the synthetic multi-view image data 104 and be detected as objects by the Sparse-MTMC model 120 as discussed above. The training dataset may be designed to support multi-class object detection, focusing on common objects found in indoor environments (e.g., warehouses). For example, a 3D simulation platform may render objects in the simulated environments corresponding to object classes such as, but not limited to, a person, a robot, a transporter, a forklift, a box, a pallet, and/or a crate. That being said, in some embodiments, a training dataset may be designed to be generalizable across different scenarios and simulated objects, generating scenes such as warehouses, retail stores, and hospitals, providing the Sparse-MTMC model 120 with a substantial degree of versatility with respect to the environments in which it may be deployed. Moreover, because the 3D object instances generated into the simulated environment are of a known appearance, size, and/or placement, the 3D simulation platform may produce the corresponding ground truth data regarding 3D bounding shape information, instance features, and ReID features associated with pod behavior data predictions inferred by the Sparse-MTMC model 120 during training sessions. In some embodiments, ground truth depth maps may be included in the training dataset to improve model convergence and object detection accuracy by providing 3D information during training related to objects and/or surfaces included in the synthetic optical image data.

In some embodiments, a training step of the training process may include the initialization of anchors using K-Means clustering from ground truth 3D bounding shapes in the training set. In the training process, the Sparse-MTMC model 120 pipeline (e.g., as illustrated in FIG. 3) may take inputs such as, but not limited to, the synthetic multi-view optical image data, image sensor calibration parameters (e.g., intrinsic and/or extrinsic camera calibration parameters for the virtual image sensors of the pod), and the ground truth depth maps, and produces an inference output comprising predicted object behavior data. For clarity, it should be noted that depth maps need not be provided as an input to the model for production inference processes outside of training.

A training step in the training of the Sparse-MTMC model 120 may involve training on synthetic multi-view optical image data representing images captured by the virtual sensors of an image sensor pod. As such, the training process may involve splitting the simulated monitored environment into several image sensor pods (e.g., as illustrated in FIGS. 2A and 2B), each pod including multiple image sensors having a field of view over the monitored environment. That is, a pod of virtual image sensors in the simulated monitored environment may capture multi-view optical sensor data over a cumulative field of view of the combined fields of view of the individual virtual image sensors. In some embodiments, a pod of virtual image sensors may capture images from a field of view that at least partially overlaps with a field of view of another pod of image sensors. This logical division of optical sensors into pods facilitates efficient training and accurate model training by providing good camera coverage across the entire scene.

In some embodiments, training a Sparse-MTMC model 120 may involve computing one or more loss functions based on deviations between ground truth 3D bounding shapes and ground truth depth maps and the predicted object behavior data. Neural weighting factors of the Sparse-MTMC model 120 may be iteratively adjusted over a series of training steps to drive such loss functions to a minimum (e.g., within a threshold). In some embodiments, training the Sparse-MTMC model 120 employs a triplet loss function for training the ReID module 121. During training, the triplet loss may be used to refine ReID feature predictions, ensuring that each detected object has a unique representation. The triplet loss function ensures that the embeddings associated with a detected object are similar over time, while the embeddings of different objects are substantially dissimilar, enhancing the model's ability to accurately identify and track objects temporally over sequences of image frames. In some embodiments, training of the ReID module 121 may include creating “noisy” instances alongside the original instances, enabling the Sparse-MTMC model 120 to learn to correct variations and improve robustness to temporal inconsistencies.

FIG. 5 is an example data flow diagram for a process for a 3D perception-based Real-Time Location System (3D-RTLS) 500, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., processing units, processing circuitry, etc.) executing instructions stored in memory. In some embodiments, the systems, methods, and processes described herein may be executed using similar components, features, and/or functionalities to those of example computing device 800 of FIG. 8, and/or example data center 900 of FIG. 9.

As shown in FIG. 5, the 3D-RTLS 500 may receive multi-view image data 104 from a plurality of optical image sensors 102 (e.g., as discussed with respect to FIGS. 1, 2A, and 2B) deployed across a monitored environment to track the location and/or trajectory of a plurality of entities (e.g., objects, people, robots, etc.) across the monitored environment. As discussed herein, the optical image sensors 102 may be divided into groupings of image sensor pods 501, shown in FIG. 5, and image sensor pods 501-1 and 501-2 to 501-n. The 3D-RTLS 500 may obtain sets of pod behavior data 530 (e.g., BEV behavior data) where an individual set may represent behavior data associated with a specific pod of the image sensor pods 501. The plurality of optical image sensors 102 may be assigned to an image sensor pod 501, for example, based on the proximity and/or overlap and/or their individual fields of view. That is, an individual optical image sensor 102 may capture multi-view image data 104 (e.g., BEV sensor data) that represents a field of view covering at least a region of the monitored environment as viewed by that optical image sensor 102, whereas a pod 501 of optical image sensors 102 captures multi-view image data 104 representing a cumulative field of view corresponding to the combined fields of view of the individual image sensors 102 that make up that image sensor pod 501. In some embodiments, an image sensor pod 501 may capture images from a field of view that at least partially overlaps with a field of view of another of the image sensor pod 501.

As shown in FIG. 5, multi-view image data 104 from an optical image sensor pod 501 may be fed as input to a 3D perception framework 110 that processes the multi-view image data 104 associated with that particular optical image sensor pod 501, as described in this disclosure. The 3D perception framework 110 may process the multi-view image data 104 for an optical image sensor pod 501 to infer behavior data 530 for that pod 501, which may be referred to as pod behavior data 530 (e.g., as discussed with respect to FIGS. 2A and 2B). In some embodiments, the pod behavior data 130 may comprise BEV pod behavior data. As discussed herein, a 3D perception framework 110 may comprise a 3D perception-based machine learning framework having one or more machine learning models (e.g., as discussed with respect to FIG. 3) that input the multi-view image data 104 captured by the image sensors 102 of a pod 101, and that infer the pod behavior data 530. Pod behavior data 530 comprises 3D information characterizing detected objects such as 3D bounding shapes (e.g., bounding boxes) corresponding to detected objects (e.g., entities such as objects, persons, animals, machines, etc.) within the combined field of view of the pod 501, an instance feature comprising high-dimensional semantics (e.g., an object classification correlated to a 3D bounding shape classifying an object as being, for example, a persons, a box, a forklift, etc.) and may include other metadata such as short-term tracking data for detected objects and/or image frame timestamps.

In some embodiments, the 3D-RTLS 500 may comprise an MTMC tracking processor 540 that receives the pod behavior data 530 from the individual 3D perception frameworks 110 for the image sensor pods 501 (e.g., 501-1 and 501-2 to 501-n) that cover the monitored environment. The MTMC tracking processor 540 receives the pod behavior data 530 from the plurality of pods 501 and synchronizes the metadata of the pod behavior data 530 across the multiple optical sensor pods 501 with respect to temporal alignment. In some embodiments, the synchronized pod behavior data (e.g., representing a synchronized composite of the pod behavior data 530 across the pods 501-1 to 501-n) may be applied as input to a tracking algorithm (e.g., a heuristics state management-based tracking system, a machine learning-based tracking framework, etc.).

The output produced by the MTMC tracking processor 540 may comprise 3D object tracking data 560, which may include, for example, one or more of 3D bounding shapes, tracking data, instance data (semantics data such as an object classification), and/or an object ID (e.g., derived from and/or referenced to an object embedding) for the individual tracked objects detected by the MTMC tracking processor 540 based on pod behavior data 530. In some embodiments, the 3D object tracking data 560 may be used as input, for example, by one or more detected object evaluation functions 562 (e.g., analytics, query, and/or rendering systems). For example, the subject evaluation function(s) 562 may comprise a query-by-example (QBE) functionality, utilizing global IDs and behavior embeddings produced by the 3D-RTLS 500. Behavior embeddings and/or other behavior data from the 3D object tracking data 560 associated with one or more tracked objects may be stored in a database 564 (e.g., a Milvus database, vector database, and/or other vector database management systems (VDBMS)) to support long-term QBE queries spanning over selected time periods. In some embodiments, the QBE functionality may operate based on representational state transfer (REST) application programming interface (API) inputs, that may include one or more of, but not limited to, an object ID, a sensor ID, a timestamp, optional parameters like time range, match score threshold, and/or top K matches, for obtaining similar behaviors. The QBE functionality may normalize object embeddings and/or 3D bounding shape data before searching in the database 564 for similar embeddings, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods. In some embodiments, the object tracking data 560 may be generated based on queries performed using the QBE functionality. In some embodiments, the one or more detected object evaluation functions 562 may use 3D object tracking data 560 (and/or other data from the 3D-RTLS 500 representing detected objects) to control the operation of one or more machines and/or systems. For example, the detected object evaluation functions 562 may control one or more operations of an AMR and/or an ego machine, based on the location of the one or more of the tracked subjects as represented by the object tracking data 560.

In some embodiments, multi-GPU support is provided by running individual Sparse-MTMC models 120 for the 3D perception frameworks 110 for individual image sensor pods 501 on separate GPUs, which facilitates real-time inferencing on a large number of sensors by dividing those sensors into multiple image sensor pods. Multiple image sensor pods can be deployed across various processing architectures (e.g., Blackwell, Hopper, Ada Lovelace, Turing, and Ampere) with 3D perception frameworks 110 at least partially hosted as a service (e.g., a microservice) on servers of a cloud computing platform. For example, an engine file (e.g., a TensorRT model object) for implementing a 3D perception framework 110 may be generated dynamically based on the particular architecture hosting the service. In some embodiments, dynamic batch-size support (e.g., with respect to multi-view optical image data) may be used to optimize (e.g., maximizes) GPU utilization, and efficient data copying within the pipeline may be achieved using, e.g., NVIDIA Triton, leading to low-latency processing even for large-scale data.

In some embodiments, the one or more detected object evaluation functions 562 may include a rendering system to display via a UI a comprehensive view of the monitored area and visually render location and trajectory tracking data for each detected object in the monitored environment as indicated by the object tracking data 560. The rendering system may permit a user to switch between real and/or virtual camera views while tracking a subject moving through the monitored environment, to locate a current position of a specific entity within the area (e.g., based on their object ID), and/or other applications that may benefit from having a real-time spatiotemporal understanding of the location and movements of subjects of interest within the monitored area.

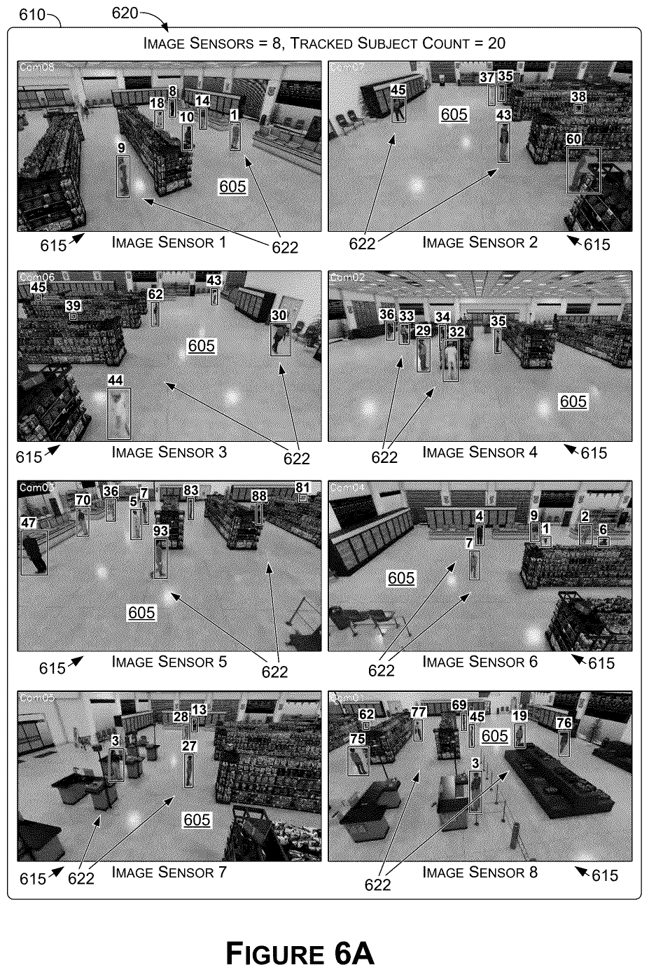

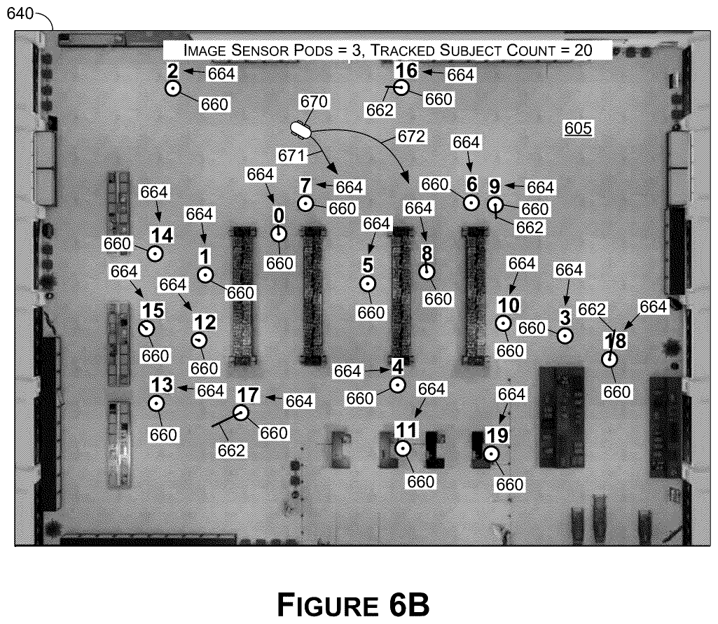

For example, FIGS. 6A and 6B are diagrams that illustrate example UIs that may be displayed using a human-machine interface coupled to the 3D-RTLS 500 (e.g., one or more of the presentation components 818 of example computing device(s) 800). In the examples of FIGS. 6A and 6B, the 3D-RTLS 500 may include a set of optical image sensors 102 that comprise a plurality of cameras arranged into image sensor pods 501 to view different portions of a monitored environment 605. The optical image sensors 102 may be grouped into a configuration of distinct image sensor pods 501, as discussed herein. It should be understood that although FIGS. 6A and 6B illustrate an example embodiment of three image sensor pods comprising two or three optical image sensors, this is for illustrative purposes and in other embodiments, the plurality of optical image sensors 102 monitoring the monitored environment 605 may comprise any number of optical image sensors 102 (e.g., tens, hundreds, or thousands), that those optical image sensors 102 may be grouped into any number of image sensor pods 501, and that any individual image sensor pod 501 may comprise any plurality of optical image sensors.

In this figure, the monitored environment 605 is depicted in the form of a grocery store, but it should be appreciated that in various embodiments, the monitored environment 605 may comprise any area where object tracking is desired such as, but not limited to, warehouses, factories, retail establishments, hospitals, office buildings, secured facilities, arenas, public transportation stations, parks, public spaces, and the like. In FIG. 6A, a UI display 610 presents a plurality of views 615 of the monitored environment 605, referenced as Image Sensors 1-8. In some embodiments, each of the views 615 may correspond to an image feed from a distinct one of the optical image sensors 102, or a computer vision-generated composite view of one of the optical image sensors 102. In some embodiments, the 3D-RTLS 500 may generate one or more of the views 615 as a display of a computer vision-based environment corresponding to a BEV viewpoint of one or more of the optical image sensors 102, and/or of a viewpoint of one or more virtual camera views instantiated within the computer vision-based environment.

As shown in FIG. 6A, each of the views 615 may present a plurality of detected objects 622, each corresponding to behavior data associated with a tracked subject within the view of the respective image sensor. In some embodiments, the 3D-RTLS 500 may display a global ID (or other individual identifier) next to their associated 3D bounding shape. In some embodiments, UI display 610 may include an information field 620 displaying information about observed tracked objects, such as the number of tracked objects presented across the multiple views 615 and/or the number of optical image sensors 102 contributing multi-view image data 104 to produce the views 615. FIG. 6B is an example UI display 640 presenting a top-down view of the monitored environment 605. In some embodiments, the UI display 640 presents virtual objects 660 (e.g., virtual people, robots, machinery, etc.) at the positions of individual tracked objects corresponding to the detected objects in the 3D object tracking data 560 as tracked by the 3D-RTLS 500. For example, in some embodiments, each of the detected objects represented by the 3D object tracking data 560 is rendered as a virtual object 660 in FIG. 6B. In some embodiments, spatiotemporal data for each detected object (e.g., based on their respective 3D bounding shape data) may be mapped to a global coordinate system of the monitored environment 605 so that the position of tracked subjects may be presented using the virtual objects 660 with respect to a common frame of reference within the UI display 640.

As the 3D object tracking data 560 is updated, the 3D-RTLS 500 may update the position and/or appearance of each virtual object 460 representation of a tracked object within the UI display 640. For each virtual object 660, the UI display 640 may include a global ID 664 (e.g., an object ID derived from an ReID feature embedding as described herein). In some embodiments, for one or more of the virtual objects 660, the 3D-RTLS 500 may update a path indicator 662 that illustrates a tracked object's past positions and/or movements over a selectable duration of time.

As discussed herein, in some embodiments, the detected object evaluation functions 562 may control one or more operations of an AMR and/or an ego machine, based on the location of the one or more of the tracked subjects as represented by the object tracking data 560. In some embodiments, the UI display 640 may display the positions and/or movements of virtual objects 660 representing tracked objects in the monitored environment 605 in relation to the positions and/or movements of one or more AMRs 670. In some embodiments, the UI display 640 may display alternate routes 671 and 672 for navigating the AMR 670 through the monitored area that avoid congestion and/or avoid interactions with tracked subjects, and/or display route-changing events due to blockages.

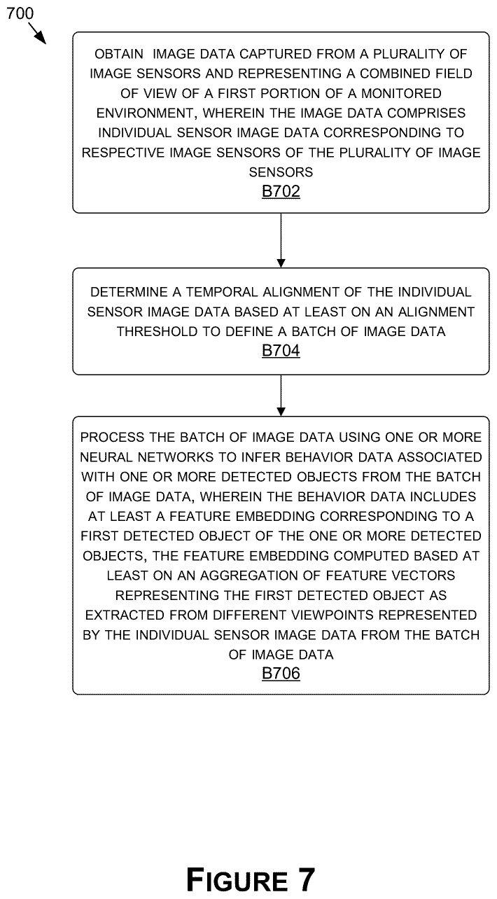

FIG. 7 is a flow diagram showing a method 700 for multi-sensor real-time subject tracking for monitored environments, in accordance with some embodiments of the present disclosure. It should be understood that the features and elements described herein with respect to the method 700 of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa.

Each block of method 700, described herein, comprises a computing process that may be performed using any combination of hardware, firmware, and/or software. For instance, various functions may be carried out by one or more processors comprising processing circuitry to execute instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the 3D perception pipeline 100 for a 3D perception-based Real-Time Location System (3D-RTLS) as shown in FIGS. 1, 2A, and 2B. However, the method may additionally or alternatively be executed by any one system, or any combination of systems, including, but not limited to, those described herein.

As discussed herein in greater detail, in some embodiments the method may generally include: generating, using one or more neural networks, inferred behavior data associated with one or more detected objects from image data, wherein the inferred behavior data includes at least a feature embedding corresponding to a first detected object of the one or more detected objects, the feature embedding computed based at least on an aggregation of feature vectors representing the first detected object as extracted from different viewpoints represented by individual sensor image data from the image data.

The method 700, at block B702, includes obtaining image data captured from a plurality of image sensors and representing a combined field of view of a first portion of a monitored environment, wherein the image data comprises individual sensor image data corresponding to respective image sensors of the plurality of image sensors. The monitored environment may be monitored using a plurality of image sensor pods, wherein a respective image sensor pod comprises one or more image sensors having a field of view of a respective portion of the monitored environment, wherein the plurality of image sensors representing the combined field of view of the first portion comprises a first image sensor pod of the plurality of image sensor pods. As shown in FIG. 1, a 3D perception pipeline 100 may receive multi-view image data 104 from a plurality of optical image sensors 102 (e.g., cameras) deployed across a monitored environment to track the location and/or trajectory of a plurality of entities (e.g., objects, people, robots, etc.) across the monitored environment, such as discussed in greater detail with respect to FIGS. 2A, 2B, and FIG. 5. As shown in FIG. 1, multi-view image data 104 from an optical image sensor pod 101 may be fed as input to a 3D perception framework 110 that processes the multi-view image data 104 associated with that particular optical image sensor pod 101. The 3D perception framework 110 may process the multi-view image data 104 for an optical image sensor pod 101 to infer pod behavior data 130 for that pod 101, which may be referred to as pod behavior data 130.

The method 700, at block B704, includes determining a temporal alignment of the individual sensor image data based at least on an alignment threshold to define a batch of image data. For example, as described herein, the image data preprocessor 118 comprises synchronization logic (e.g., synchronization logic 308, as shown in FIG. 3) that performs optical image frame synchronization for the multi-view frames of the multi-view image data 104 for image sensor pod 101 prior to the input of the optical image data to the Sparse-MTMC model 120. The individual incoming frames of multi-view image data 104 may be batch-processed by the synchronization logic 308 to align the frames temporally (e.g., based on timestamp metadata applied by the image sensors) such that the frames received at the Sparse-MTMC model 120 are within a predetermined time window (e.g., within an alignment threshold of each other). The method may further extract the one or more detected objects from the batch of image data using a feature pyramid network (FPN). That is, in some embodiments, the deformable aggregation 314 may process the synchronized multi-view image data 104 through a backbone and a feature pyramid network (FPN) to extract multiscale features, providing a rich spatial representation of the scene monitored by that image sensor pod.

The method 700, at block B706, includes processing the batch of image data using one or more neural networks to infer behavior data associated with one or more detected objects from the batch of image data, wherein the behavior data includes at least a feature embedding corresponding to a first detected object of the one or more detected objects, the feature embedding computed based at least on an aggregation of feature vectors representing the first detected object as extracted from different viewpoints represented by the individual sensor image data from the batch of image data.

In some embodiments, at least one neural network of the one or more neural networks comprises a Sparse-based multi-view temporal perception model. As shown in FIG. 1, a 3D perception framework 110 may comprise a Sparse-MTMC pipeline 112 for generating pod behavior data 130 from multi-view image data 104. The Sparse-MTMC pipeline 112 may include, for example, a preprocessor 118, a Sparse-MTMC model 120, and a post-processor 122. The Sparse-MTMC model 120 may include an integrated ReID module 121 for generating ReID feature embeddings as discussed herein. The ReID module 121 facilitates long-term tracking of detected objects across a monitored environment-which permits the 3D perception framework to maintain consistent identification of tracked objects over extended periods, even as they move through different parts of the environment or are temporarily occluded. The at least one neural network of the one or more neural networks may comprise an encoder-decoder architecture and includes at least a spatial aggregation stage and a temporal tracking stage, wherein the feature embedding is computed by the temporal tracking stage. As illustrated in FIG. 3, a Sparse-MTMC model 120 of the 3D perception framework 110 may include a pipeline that comprises layers of a machine learning-based neural network divided into an initial spatial aggregation stage 302 followed by a temporal tracking stage 304. In some embodiments, the functions of the ReID module discussed herein may be implemented by the temporal tracking stage 304. In some embodiments, the Sparse-MTMC model 120 architecture may be based on an encoder-decoder structure. As shown in FIG. 3, inputs to the Sparse-MTMC model 120 pipeline may include: multi-view image data 104 corresponding to the optical image data from the cameras of an image sensor pod, newly initialized instance features 312, and/or previous pod behavior data 342, which may include propagated object features computed for a previous frame of optical image data from the image sensor pod.

The method may include processing the batch of image data using the one or more neural networks to further infer behavior data including: a representation of one or more 3D bounding shapes associated with the one or more detected objects, and one or more instance features comprising an object classification correlated to the one or more 3D bounding shapes. The output of the pipeline, as discussed above, may include pod behavior data 130, which includes for one or more objects detected from the multi-view image data 104: a 3D bounding shape that describes the position, size, and/or orientation of a detected object, an instance feature comprising high-dimensional semantics (e.g., an object classification correlated to the 3D bounding shape), and 3D ReID features comprising an object embedding.

In some embodiments, the method may compute a respective visibility score representing a visibility for the first detected object from the different viewpoints as represented by the individual sensor image data from the batch of image data, and compute the aggregation of the feature vectors representing the first detected object based at least on a weighted aggregation using the respective visibility scores. As discussed with respect to FIG. 3, the ReID module 121 may perform a visibility assessment 334 (e.g., a VisibilityNet module) to address the issue of some projected 2D points falling outside image boundaries or being occluded. The visibility assessment 334 may comprise a module that computes and assigns a visibility score on a per-camera basis to each view of an extracted feature of the detected object. In some embodiments, to generate a 3D ReID feature embedding for an object, the ReID feature aggregation 332 may aggregate features from the different image sensor views based on the visibility scores computed by the visibility assessment 334.

The method may include processing the batch of image data using the one or more neural networks to infer the behavior data based at least on an input to the one or more neural networks comprising an encoding of calibration parameters for the plurality of image sensors. For example, in some embodiments, encoded camera parameters 340 (e.g., intrinsic and/or extrinsic calibration parameters for one or more of the optical image sensors 102), may be input to the deformable aggregation 314 and used to project 3D feature information into 2D and then back to 3D, obtaining real 3D features from 2D data. A camera encoding module may receive camera parameters associated with the image sensors that make up an image sensor pod (e.g., intrinsic and extrinsic camera calibration parameters) directly encoding camera placement information by assigning per-camera weights predicted from sampled image features per camera. Intrinsic camera calibration parameters included in a camera encoding may include, for example, field of view angle and focal length, while extrinsic camera calibration parameters included in a camera encoding may include, for example, 3D mounting point coordinates and/or rotation and translation information (e.g., a rotation transformation matrix). In some embodiments, the one or more neural networks may be trained based at least on a 3D synthetic training dataset generated by a 3D simulation platform, wherein the 3D synthetic training dataset comprises synthetic image data of a scene and ground truth depth map data for objects or surfaces represented in the synthetic image data. Moreover, in some embodiments, the one or more neural networks may be trained to generate the ReID feature embedding based at least on iteratively adjusting the one or more neural networks to drive a triplet loss function towards a minimum loss.

In some embodiments, the method may include controlling an operation of a machine navigating through the monitored environment based at least on the behavior data associated with the one or more detected objects. As an example, behavior data associated with the one or more detected objects may be used to generate 3D object tracking data such as 3D object tracking data 560. The one or more detected object evaluation functions 562 may use 3D object tracking data 560 (and/or other data from the 3D-RTLS 500 representing detected objects) to control the operation of one or more machines and/or systems. For example, the detected object evaluation functions 562 may control one or more operations of an AMR and/or an ego machine, based on the location of the one or more of the tracked subjects as represented by the object tracking data 560. In some embodiments, the method may cause a display of a computer vision-based view of one or more tracked subjects for at least part of the monitored environment based at least on the behavior data associated with the one or more detected objects. For example, FIGS. 6A and 6B are diagrams that illustrate example UIs that may be displayed using a human-machine interface coupled to the 3D-RTLS 500 that may be generated based on behavior data associated with the one or more detected objects. As shown in FIG. 6A, each of the views 615 may present a plurality of detected objects 622 each corresponding to behavior data associated with a tracked subject within the view of the respective image sensor. FIG. 6B is an example UI display 640 presenting a top-down view of the monitored environment 605. In some embodiments, the UI display 640 presents virtual objects 660 (e.g., virtual people, robots, machinery, etc.) at the positions of individual tracked objects corresponding to the detected objects in the 3D object tracking data 560 as tracked by the 3D-RTLS 500.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes image data captured by a plurality of fixed mounted optical image sensors deployed to monitor an environment within the simulation environment—and those optical image sensors are extrinsically calibrated together based on fixed mounted optical image sensor calibration parameters to produce a 3D reconstruction of the monitored environment. The simulation environment may use this image data and/or fixed mounted optical image sensor calibration parameter information to perform operations (e.g., navigating) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce processed image data related to animated or static objects, hazards, etc., which may be used or included in a visualization or mapping of an environment to aid a remote operator in controlling—or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more application programming interfaces (APIs) that connect to cloud services, enabling the system to process requests in real-time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers, etc.) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), large language models (LLMs), multimodal language models (MMLMs), diffusion models, NeRF models, deep neural networks (DNNs), etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multimodal language models, perception models, tracking models, fusion models, transformer models, diffusion models, encoder-only models, decoder-only models, encoder-decoder models, neural rendering field (NeRF) models, etc.) described herein may be packaged as one or more cloud-hosted microservices—such as one or more inference microservice(s) (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device or up to data-center scale). As such, the inference microservice may include the machine learning model(s) (e.g., that has been optimized for high-performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models such as one or more large language models (LLMs), systems for performing light transport simulation, systems for performing collaborative content creation for 3D assets, systems implemented at least partially using cloud computing resources, and/or other types of systems.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof. In some embodiments, one or more aspects of the 3D perception framework(s) 110 and/or 3D-RTLS 500, may be implemented at least in part by processing circuitry of computing device 800 (e.g., CPU(s) 806, GPU(s) 808 and/or logic unit(s) 820).

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

In some embodiments, one or more aspects of the 3D perception framework(s) 110 and/or 3D-RTLS 500, may be executed at least in part by CPU(s) 806, GPU(s) 808 and/or logic unit(s) 820). For example, in some embodiments sparse-MTMC model 120 may comprise neural-network-based machine learning models executed by GPU(s) 808.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality content or virtual reality content.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.). In some embodiments, the 3D-RTLS 500 or other system may present a representation of pod behavior data 130 and/or object tracking data 560 using a user interface (such as illustrated in FIGS. 6A, 6B) on presentation component(s) 818.

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940. For example, one or more functions of the 3D perception framework(s) 110 and/or 3D-RTLS 500, may be implemented at least in part as network services (e.g., microservices) hosted by one or more servicer of data center 900.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM). In some embodiments, one or more aspects of the 3D perception framework(s) 110 and/or 3D-RTLS 500 may be implemented at least in part by one or more of the node C.R.s 916(1)-916(N). For example, sparse-MTMC model 120 may be implemented on one or more vGPUs and/or vCPUs.

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources. In some embodiments, one or more aspects of the 3D perception framework(s) 110 and/or 3D-RTLS 500, may be performed by executing one or more of applications 942 and/or software 932.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain image data captured from a plurality of image sensors and representing a combined field of view of a first portion of a monitored environment, wherein the image data comprises individual sensor image data corresponding to respective image sensors of the plurality of image sensors;
determine a temporal alignment of the individual sensor image data based at least on an alignment threshold to define a batch of image data; and
process the batch of image data using one or more neural networks to infer behavior data associated with one or more detected objects from the batch of image data, wherein the behavior data includes at least a feature embedding corresponding to a first detected object of the one or more detected objects, the feature embedding computed based at least on an aggregation of feature vectors representing the first detected object as extracted from different viewpoints represented by the individual sensor image data from the batch of image data.

2. The one or more processors of claim 1, wherein the one or more processors are further to process the batch of image data using the one or more neural networks to infer further behavior data including: a representation of one or more 3D bounding shapes associated with the one or more detected objects, and one or more instance features comprising an object classification correlated to the one or more 3D bounding shapes.

3. The one or more processors of claim 2, wherein the one or more 3D bounding shapes associated with the one or more detected objects indicate at least one of a 3D position, a 3D size, or an orientation of the one or more detected objects.

4. The one or more processors of claim 1, wherein the one or more processors are further to:
compute respective visibility scores representing a visibility for the first detected object from the different viewpoints as represented by the individual sensor image data from the batch of image data; and
compute the aggregation of the feature vectors representing the first detected object based at least on a weighted aggregation using the respective visibility scores.

5. The one or more processors of claim 1, wherein the one or more processors are further to:
extract the one or more detected objects from the batch of multi-view image data using a feature pyramid network (FPN).

6. The one or more processors of claim 1, wherein the at least one neural network of the one or more neural networks comprises an encoder-decoder architecture and includes at least a spatial aggregation stage and a temporal tracking stage, wherein the feature embedding is computed by the temporal tracking stage.

7. The one or more processors of claim 1, wherein the one or more processors are further to:
process the batch of image data using the one or more neural networks to infer the behavior data based at least on an input to the one or more neural networks comprising an encoding of calibration parameters for the plurality of image sensors.

8. The one or more processors of claim 1, wherein the monitored environment is monitored using a plurality of image sensor pods, wherein a respective image sensor pod comprises one or more image sensors having a field of view of a respective portion of the monitored environment, wherein the plurality of image sensors representing the combined field of view of the first portion comprises a first image sensor pod of the plurality of image sensor pods.

9. The one or more processors of claim 1, wherein at least one neural network of the one or more neural networks comprises a Sparse-based multi-view temporal perception model.

10. The one or more processors of claim 1, wherein at least one neural network of the one or more neural networks is trained based at least on a 3D synthetic training dataset generated by a 3D simulation platform, wherein the 3D synthetic training dataset comprises synthetic image data of a scene and ground truth depth map data for objects or surfaces represented in the synthetic image data.

11. The one or more processors of claim 1, wherein at least one neural network of the one or more neural networks is trained to generate the feature embedding based at least on iteratively adjusting one or more parameters of at least one neural network of the one or more neural networks to drive a triplet loss function towards a minimum loss.

12. The one or more processors of claim 1, wherein the processing circuitry is further to:
cause a display of a computer vision-based view of one or more tracked subjects for at least part of the monitored environment based at least on the behavior data associated with the one or more detected objects.

13. The one or more processors of claim 1, wherein the processing circuitry is further to:
control an operation of a machine navigating through the monitored environment based at least on the behavior data associated with the one or more detected objects.

14. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or a system implemented at least partially using cloud computing resources.

15. A system comprising one or more processors to:
obtain image data captured from a plurality of image sensors, the plurality of optical image sensors comprising a first image sensor pod representing a combined field of view of a first portion of a monitored environment and a second image sensor pod representing a combined field of view of a second portion of the monitored environment;
process a first batch of image data associated with the first image sensor pod, using one or more first neural networks to infer first behavior data associated with one or more first detected objects from the first batch of image data, wherein the first behavior data includes at least a first feature embedding corresponding to a detected object of the one or more first detected objects;
process a second batch of image data associated with the second image sensor pod, using one or more second neural networks to infer second behavior data associated with one or more second detected objects from the second batch of image data, wherein the second behavior data includes at least a second feature embedding corresponding to a detected object of the one or more second detected objects, wherein the first batch of image data and the second batch of image data are temporally aligned within an alignment threshold and processed at least partially in parallel; and
generate, based at least on the first behavior data and the second behavior data, an object features output to a real-time location system.

16. The system of claim 15, wherein the one or more processors are further to execute a synchronization logic that aligns frames of the multi-view image data temporally within a predetermined alignment threshold.

17. The system of claim 15, wherein the one or more processors are further to compute at least one of the first feature embedding or the second feature embedding based at least on an aggregation of feature vectors as extracted from different viewpoints as represented by the image data, wherein the aggregation is computed based at least on respective visibility scores representing a visibility of the one or more detected objects as extracted from the different viewpoints as represented by the image data.

18. The system of claim 15, wherein at least one of the first behavior data or the second behavior data may further include: a representation of one or more 3D bounding shapes, and one or more instance features comprising an object classification correlated to the one or more 3D bounding shapes.

19. The system of claim 15, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or a system implemented at least partially using cloud computing resources.

20. A method comprising:
generating, using one or more neural networks, inferred behavior data associated with one or more detected objects from image data, wherein the inferred behavior data includes at least a feature embedding corresponding to a first detected object of the one or more detected objects, the feature embedding computed based at least on an aggregation of feature vectors representing the first detected object as extracted from different viewpoints represented by individual sensor image data from the image data.
